(19) United States
(12) Patent Application Publication
(10) Pub. No.: US 2011/0023278 A1
(43) Pub. Date: Feb. 3, 2011

(54) LOCK RING MOUNTING/DEMOUNTING JIG

(76) Inventors: Kentaro Oba, Tokyo (JP); Yukio Nakamura, Tokyo (JP); Etsuro Sugisaki, Tokyo (JP)

Correspondence Address: SMITH PATENT OFFICE, 1901 PENNSYLVANIA AVENUE N W, SUITE 901, WASHINGTON, DC, 20006, US

(21) Appl. No.: 12/673,732

(22) PCT Filed: Aug. 13, 2008
(86) PCT No.: PCT/JP2008/064519

§ 371 Date: Feb. 16, 2010

(30) Foreign Application Priority Data
Aug. 14, 2007 (JP) 2007-211262
Aug. 12, 2008 (JP) 2008-207873

(51) Int. Cl. B25B 27/14

(52) U.S. Cl. 29/235

(57) ABSTRACT

It is intended to provide jigs enabling a worker to hold a lock ring while resisting the elastic repulsion force urging contraction of the lock ring, inward in the radial direction, without the need for propping up a heavy lock ring.

There is provided a lock ring mounting/demounting jig, the jig including two jigs in pairs, the jigs (41, 42) in pairs, constituting the jig, being joined with each other by a screw bolt (8), in which the jigs in pairs are mountable on respective ends (4a, 4b) of a lock ring (4), the jigs (41, 42) each include a main block (41B, 42B) and a clamp (41C, 42C), and the jigs (41, 42, 410, 420, 411, 421) in pairs are structured such that an interval therebetween is stretchable.

### TECHNICAL FIELD

The present invention relates to a multi-piece rim to be fitted to a tire for use in a construction machine or mining machine, and particularly, a multi-piece rim to be fitted to a tire for use in a large-sized construction machine or mining machine.

### BACKGROUND ART

The tire for use in the large-sized construction machine or mining machine differs in rigidity from a tire for use in a passenger car, so that the tire for use in the large-sized construction machine or mining machine does not fit into a single-piece rim on many occasions. For this reason, a multi-piece rim is often used in the large-sized construction machine or mining machine.

In FIG. 51, there is shown a construction of such a multi-piece rim. In FIG. 51, a multi-piece rim 100J has a rim base 1, a side ring 2 provided on the right and left sides of a tire, respectively, a bead sheet band 3 and a lock ring 4. An end of the rim base 1, on a side thereof, adjacent the lock ring 4, (the right-side end of the rim base 1, in FIG. 51) is called a gutter band 11. A back flange 12 is formed at an end of the rim base 1, on the left side thereof. Further, in FIG. 51, a construction for fitting the multi-piece rim to a side of the tire, adjacent to the construction machine or the mining machine, (to a hub) is not illustrated.

In FIG. 51, when air is pumped into a tire 6, and air pressure in the tire 6 rises, the tire is inflated in both the right and left directions FIG. 51, inducing the respective side rings 2 on the left and right sides of the tire, in FIG. 51, to move in the right and left directions, respectively, whereupon the bead sheet band 3 moves in the direction of the arrow Y.

The lock ring 4 is fitted into a groove 11a formed in the gutter band 11, and the gutter band 11 is formed integrally with the rim base 1. Accordingly, the lock ring 4 restricts movement of the side ring 2, and the bead sheet band 3, provided on the right side, toward the right-hand side in FIG. 51.

FIG. 52 shows the lock ring 4 formed as a single component (single piece). The lock ring 4 in a single piece has elasticity, particularly, elastic repulsion force acting in the direction of contraction occurring in the direction of the arrow R in FIG. 52 (inwardly in the radial direction), and a break 4s is formed at one spot thereof. However, with the lock ring 4 in a single piece state, that is, when it is not fitted to a rim, the break 4s is closed by the agency of the elastic repulsion force of the lock ring 4.

Unless the lock ring 4 has the elastic repulsion force acting in the direction of contraction occurring inwardly in the radial direction (in the direction of the arrow R in FIG. 52), there is the risk that the lock ring 4 while in use is forced out of the groove 11a (refer to FIG. 51) formed in the gutter band 11. By the agency of the elastic repulsion force causing contraction in the radial direction (in the direction of the arrow R in FIG. 52), the lock ring 4 remains fitted in, and held by the groove 11a.

With some large-sized construction machine or mining machine, double tires are provided on a rear wheel side thereof. The double tires are constructed such that a tire and a rim are provided on both the inner and outer sides thereof.

With multi-piece rims 100, 100J, shown in FIG. 53, in the case where such a lock ring 4 in a single piece as shown in FIG. 52 is used, and the lock ring 4 is to be attached to the multi-piece rim 100 on the outer side, or the multi-piece rim 100J on the inner side, it is required that the lock ring 4 be fitted into the groove 11a (refer to FIG. 51) of the gutter band 11 by causing the lock ring 4 to pass through a rim base 1 of the multi-piece rim 100 on the outer side while holding the lock ring 4 in a state where a large size in the radial direction thereof (in the direction of the arrow R in FIG. 52) is maintained against the urging of elastic repulsion force (the elastic repulsion force causing the contraction in the direction of the arrow R in FIG. 52).

Herein, since there is the case where the lock ring 4 has a mass as large as, for example, on the order of 50 kg, it is extremely difficult to hold the lock ring 4 so heavy in weight while resisting the elastic repulsion force urging the contraction in the radial direction and to dispose the same at a predetermined position, and excessive labor will be required.

As other prior art, there has been proposed, for example, a multi-piece rim disc wheel wherein a rim base, a gutter band, first and second center bands, a disc, and a back flange are joined together by use of complete joint penetration butt welding, capable of coping with an increase in payload (refer to Patent Publication 1).

Such prior art can be useful, however, it does not eliminate a problem associated with mounting/demounting of the lock ring, described as above.
Patent Publication 1: JP-A No. 2000-108603

### DISCLOSURE OF THE INVENTION

### Problems to be Solved by the Invention

The present invention has been developed in view of the problem with the prior art, described as above, and it is an object of the invention to provide a safe jig with which a worker is able to mount a lock ring on a rim base without the need for holding the lock ring against elastic repulsion force urging contraction of the lock ring, inwardly in the radial direction, and the need for supporting the weight of the lock ring.

### Means of Solving the Problems

A lock ring mounting/demounting jig according to the invention, includes two jigs in pairs, the jigs (41, 42, 410, 420, 411, 412, 421, 422, 460, 462) in pairs being mountable on respective ends (4a, 4b) of a lock ring (4), wherein the jigs (41, 42, 410, 420, 411, 412, 421, 422, 460, 462) in pairs are constructed such that an interval between the jigs in pairs is stretchable (claim 1).

The lock ring mounting/demounting jig according to the invention, preferably includes a perfect circle holding mechanism (480, 482) for suppressing the lock ring (4) from being deformed into the shape of an ellipse when the interval between the jigs (460, 462) is stretched, or shrunk, thereby holding the lock ring (4) in the state of a perfect circle or an approximately perfect circle (claim 2: FIGS. 32, 33, and FIGS. 35 to 50).

The jig according to the invention, is preferably constructed such that the jigs (41, 42) in pairs, constituting the jig (40), are joined with each other by a screw bolt (8), the jigs (41, 42) each include a main block (41B, 42B) and a clamp (41C, 42C), the main block (41B, 428) is provided with a female screw (41h, 42h), penetrating therethrough, the clamp (41C, 42C) as a whole is formed in a shape resembling the letter U, having an upper flange (Cfu), and a lower flange (Cfd), the upper flange (Cfu) is provided with a through-hole Cuh with a female screw formed therein, a clamp bolt (9) being in mesh with the female screw of the through-hole (Cuh), the lower flange (Cfu) is structured such that a tip (Cfde) thereof is in a pointed shape, the screw bolt (8) has a male screw, the male screw being in mesh with the female screw (41h, 42h), penetrating through the jigs (41, 42) in pairs, respectively, the female screw (41h, 42h) formed in one of the jigs (41, 42) in pairs, so as to penetrate therethrough, has a thread reverse in orientation to (“inversely threaded in orientation against”) a thread of the female screw (41h, 42h) formed in the other of the jigs (41, 42) so as to penetrate therethrough, and the male screw (81, 82) in a region of the screw bolt (8), penetrating through the one of the jigs (41, 42), in mesh with the female screw (41h, 42h) formed in the one of the jigs (41, 42), has a thread reverse in orientation to a thread of (“inversely threaded in orientation against”) the male screw (81, 82) in the region of the screw bolt (8), penetrating through the other of the jigs (41, 42), in mesh with the female screw (41h, 42h) formed in the other of the jigs (41, 42), respectively (claim 3).

In the present specification, terms “rim”, “multi-piece rim”, and “rim base” are used for a wheel provided with a disc.

The jig (410, 420) for mounting and/or demounting a lock ring according to the invention, is preferably constructed such that the main block is a block (432) with a female screw (438) formed therein so as to penetrate therethrough while the clamp is composed of two clamp members (434, 436) with the block (432) sandwiched therebetween, the block (432) is provided integrally with two lengths of shafts (440, 442), the shafts each being extended in a direction orthogonal to the axial direction of the female screw (438) penetrating through the block (432), an opening (through-opening) is formed in each of the clamp members (434, 436), the shaft (440, 442) of the block (432) being inserted into the opening of the clamp member (434, 436), and a through-hole (450) is formed in the clamp member (434, 436), the clamp members (434, 436), in a state holding the block (432) sandwiched therebetween, being integrally joined with the block (432) by a bolt (452) inserted into the through-hole (450) (claim 4).

In this case, the opening (through-opening) is preferably a long hole (446, 448) have a major axis in the radial direction of the lock ring (4) (for example, in the direction indicated by the arrow R in FIG. 36).

Otherwise, use may be made of an opening (446C, 448C) circular in cross section (refer to FIG. 39). Needless to say, the shape of the opening is not limited to a long hole or a circle.

The perfect circle holding mechanism according to the invention is not limited to the above-described mechanism (construction as set forth in claim 3, or 4). For example, the perfect circle holding mechanism is preferably provided with a frame (500) resembling the letter U in cross section, surrounding the lock ring 4, and a protrusion (510) formed on each arm portion (502) of the frame 500, the protrusion (510) being disposed so as to be butted against the lock ring (4) in order to stop the lock ring (4) from being deformed into the shape of a warped ellipse (FIG. 40).

Otherwise, the perfect circle holding mechanism is preferably constructed to comprise a bar-like member (470) joined to the clamp member (434, 436), extending along a direction of the tangent of the lock ring (4), and a butting member (480, 482), crossing the bar-like member (470) at right angles, or extending in the radial direction of the lock ring (4), the butting member (480, 482) being butted against the lock ring (4), thereby increasing bending moment such that portions of the lock ring (4), in neighborhood of the respective ends of the lock ring (4), are expanded outward in the radial direction (FIGS. 41 to 43).

Further, a flare-suppressor member (495) serving as the perfect circle holding mechanism is preferably disposed at a spot of the lock ring (4), where the largest bending moment is in action when the interval between the jigs(410,420) mounted on the respective ends (4a, 4b) of the lock ring (4) is stretched or shrunk, in such a way as to surround a part of the lock ring (4), in the circumferential direction thereof, thereby causing flare-suppressor member (495) to interfere with the lock ring (4) tending to expand outward in the radial direction thereof, and suppressing the lock ring (4) from flaring outward in the radial direction thereof (refer to FIGS. 44 to 46).

Still further, the lock ring (4) is preferably structured so as to be varied in cross-sectional shape according to a region thereof, in the circumferential direction of the lock ring (4), (cross-section along line A-A, cross-section along line B-B, and cross-section along line C-C) such that rigidity of the lock ring (4) is rendered larger in value in a region of the lock ring (4), where the largest bending moment is acting, as compared with other regions of the lock ring (4), when the interval between the jigs (410, 420) mounted on the respective ends (4a, 4b) of the lock ring (4) is stretched or shrunk (FIGS. 47 to 50).

For example, if a cutoff part (4C1, 4C2) is provided in a region of the lock ring 4, other than the region where the largest bending moment is acting, this will enable the rigidity of the lock ring (4), in the region where the largest bending moment is acting, to become the largest (FIG. 48).

Otherwise, if a reinforcement member 4F is formed in the region of the lock ring 4, where the largest bending moment is acting, this will enable the rigidity of the lock ring 4, in the region where the largest bending moment is acting, to become the largest (FIGS. 49, 50).

A method for mounting the lock ring with the use of the jigs described as above (the jigs according to any of claims 1-4) comprises the step of mounting each (41, 42) of the two jigs in pairs, making up the jig (40), on the respective ends 4a, 4b of the lock ring (4), (FIGS. 4 to 9), the step of causing the jigs (41, 42) to be parted from each other by turning a screw bolt (8) to increase a distance (L) between respective end faces (4ae, 4be) of the lock ring (4), thereby rendering the inside diameter of the lock ring (4) (the inside diameter of the lock ring 4, at the apex of a protrusion 4t, on the inside diameter side thereof: ΦD1) larger than the outside diameter (ΦD2) of a gutter band (11) (FIGS. 10,11), the step of causing the protrusion (4t) in a region in close proximity to the respective ends of the lock ring (4) to be engaged with a lock ring groove (11a) of the gutter band (11) (FIGS. 12 to 14), the step of causing the jigs (41, 42) to approach each other by turning a screw bolt (8) to decrease the distance (L) between respective end faces (4ae, 4be) of the lock ring (4), thereby engaging the lock ring 4 with the lock ring groove 11a of the gutter band 11, along the whole circumference of the lock ring 4 (FIGS. 15 to 17), and the step of demounting the jig (40: 41, 42) from the respective ends (4a, 4b) of the lock ring (4) (FIG. 18).

The method for mounting the lock ring, described as above, is preferably carried out in parts of double tires, where a rim on the inner side thereof is opposed to a rim on the outer side thereof (regions denoted by reference numerals C1, C2, respectively, in FIG. 3).

A method for demounting the lock ring with the use of the jigs described as above (the jigs according to any of claims 1-4) comprises the step of causing the tip (Cfde) of the lower flange of the clamp (41C, 42C) of the jig (40: 41, 42) to advance along a joining surface (a boundary surface) between the lock ring (4), and the gutter band (11), thereby fitting each (41, 42) of the two jigs in pairs, making up the jig (40), to the joining surface (the boundary surface) between the end (4a, 4b) of the lock ring (4), and the gutter band (11) (FIGS. 19 to 22), the step of causing the jigs (41, 42) to be parted from each other by turning the screw bolt (8) to increase the distance (L) between respective end faces (4ae, 4be) of the lock ring (4), thereby rendering the inside diameter of the lock ring (4) (the inside diameter of the lock ring (4), at the apex of the protrusion (4t), on the inside diameter side thereof: ΦD1) larger than the outside diameter (ΦD2) of the gutter band (11) (FIGS. 24 to 26), the step of disengaging the protrusion (4t) of the lock ring (4) from the groove (11a) of the gutter band (11) to thereby demount the lock ring (4) from the rim base (1) (FIGS. 27 to 29), the step of causing the jigs (41,42) to approach each other by turning a screw bolt (8) to thereby decrease the distance (L) until the respective end faces (4ae, 4be) of the lock ring (4) come into contact with each other (FIG. 30), and the step of demounting the jig (40: 41, 42) from the respective ends (4a, 4b) of the lock ring 4 (FIG. 31).

The method for demounting the lock ring, described as above, is preferably carried out in the parts of double tires, where the rim on the inner side thereof is opposed to the rim on the outer side thereof (the regions denoted by reference numerals C1, C2, respectively, in FIG. 3).

### Effects of the Invention

With the invention having such a construction as described in the foregoing, since the jigs (41, 42, 410, 420, 411, 412, 421, 422, 460, 462) in pairs, mounted on the respective ends (4a, 4b) of the lock ring (4) are constructed such that the interval between the jigs in pairs is stretchable, it is possible to maintain with ease and certainty a state where the inside diameter of the lock ring (4) (the inside diameter of the lock ring (4), at the apex of the protrusion (4t,) on the inside diameter side thereof: ΦD1) is larger than the outside diameter (ΦD2) of the gutter band (11) at the time of mounting and demounting the lock ring 4.

For example, upon mounting of the lock ring (4), if the jigs (41, 42) in pairs, constituting the jig (40), mounted on the ends (4a, 4b) of the lock ring are parted further from each other by turning the screw bolt (8) while resisting elastic repulsion force of the jig (40), urging contraction in the radial direction thereof, thereby increasing the distance (L) between respective end faces (4ae, 4be) of the lock ring (4), it is possible to maintain with ease and certainty the state where the inside diameter of the lock ring (4) (the inside diameter of the lock ring (4), at the apex of the protrusion (4t,) on the inside diameter side thereof: ΦD1) is larger than the outside diameter (ΦD2) of the gutter band (11).

Hence, it is possible to eliminate the need for forcing a worker to carry out a job of holding a lock ring so as to be disposed at a predetermined position while resisting the elastic repulsion force urging contraction of the lock ring, inward in the radial direction, as in the case of mounting a single-piece lock ring in the past, the job being extremely difficult and requiring excessive labor, so that the job can be easily and safely carried out.

Further, with the invention, the protrusion (4t) in the region in close proximity to the respective ends of the lock ring (4) is engaged with the groove (11a) of the gutter band (11), and the jigs (41, 42) are caused to approach each other by turning the screw bolt (8) to thereby decrease the distance (L) between the respective end faces (4ae, 4be) of the lock ring (4), whereupon the lock ring (4) can be engaged with the lock ring groove (11a) of the gutter band (11), along the whole circumference of the lock ring (4). For this reason, it is only during a brief period of such a job as described above that the lock ring (4) need be propped up, so that there is no need for a worker to prop up a heavy lock ring for many hours while resisting the elastic repulsion force of the lock ring upon mounting the lock ring (4) at the predetermined position, and a whole work can be easily and safely carried out.

Still further, with the invention, if the jigs (41, 42) are caused to approach each other by, for example, turning the screw bolt (8), the lock ring (4) can be engaged with the lock ring groove (11a) by the agency of the elastic repulsion force tending to contract inward in the radial direction.

Accordingly, engagement of the lock ring (4) against the lock ring groove (11a) is ensured, and there will be no possibility that the lock ring is disengaged from the lock ring groove (11a) by the agency of force caused by air pressure of a tire, acting in an axial direction, (force in the direction of the arrow Y in FIG. 51) when air is pumped into the tire.

Since the lock ring (4) is engaged with the lock ring groove 11a of the gutter band 11 with certainty, the tire (6) can be accurately assembled with the rim (100).

Further, with the invention having such a construction as described in the foregoing, since the lower flange tip Cfde of the clamp (41C, 42C) is, for example, in the pointed shape, the lower flange Cfd of the clamp (41C, 42C) is allowed to easily advance along the joining surface (the boundary surface) between the lock ring (4), and the gutter band (11) upon demounting of the lock ring (4), thereby enabling each of the two jigs in pairs, making up the jig (40: 41, 42) to be easily fitted to the joining surface (the boundary surface) between each of the respective ends (4a, 4b) of the lock ring (4), and the gutter band (11).

Still further, as is the case with the method for mounting the lock ring, described in the foregoing, the respective end faces 4ae, 4be of the lock ring ends 4a, 4b are parted from each other by turning, for example, the screw bolt 8 to thereby increase the distance L between the respective end faces 4ae, 4be of the lock ring 4, and by so doing, it is possible to maintain a state where the inside diameter of the lock ring (4) (the inside diameter of the lock ring (4), at the apex of the protrusion (4t,) on the inside diameter side thereof: ΦD1) is larger than the outside diameter (ΦD2) of the gutter band (11).

Hence, it is possible to eliminate the need for forcing a worker to carry out the job of holding a lock ring so as to be disposed at a predetermined position while resisting the elastic repulsion force urging contraction of the lock ring, inward in the radial direction, as in the case of mounting the single-piece lock ring in the past, the job being extremely difficult and requiring excessive labor, so that the job can be easily and safely carried out.

Furthermore, with the invention, since it is possible to disengage the protrusion (4t) of the lock ring (4) from the lock ring groove (11a) of the gutter band (11) while holding the state where the inside diameter of the lock ring (4) (the inside diameter of the lock ring (4), at the apex of the protrusion (4t,) on the inside diameter side thereof: ΦD1) is larger than the outside diameter (ΦD2) of the gutter band (11) to thereby demount the lock ring (4) from the rim base (1). Therefore, it is only during a brief period of such a job as described above that the lock ring (4) need be propped up, so that there is no need for a worker to prop up a heavy lock ring for many hours while resisting the elastic repulsion force of the lock ring upon demounting the lock ring (4).

Further, if the lock ring mounting/demounting jig, according to the invention, comprises the perfect circle holding mechanism (480, 482) (claim 2), the lock ring (4) can be checked from being deformed into the shape of the ellipse when the interval between the jigs (41, 42, 410, 420, 411, 412, 421, 422, 460, 462) is stretched, or shrunk (stretched, or expanded, in particular), thereby flaring the lock ring (4) while being held in the state of a perfect circle or an approximately perfect circle.

Accordingly, upon mounting/demounting the jigs (41, 42, 410, 420, 411, 412, 421, 422, 460, 462) on the gutter band (11) by stretching the interval therebetween, the lock ring (4) can be fitted to the jigs with ease.

### BEST MODE FOR CARRYING OUT THE INVENTION

Embodiments of the invention are described hereinafter with reference to the accompanying drawings.

In FIGS. 1, and 2, there are shown respective ends 4a, 4b of a lock ring 4 mounted on a gutter band 11, and a jig 40 mounted on the respective ends 4a, 4b, according to a first embodiment of the invention.

In FIG. 1, a portion of a multi-piece rim to which the first embodiment shown in the figure is applied, is partially shown by reference numeral 100. More specifically, the gutter band 11 and the lock ring 4, as parts of the multi-piece rim 100, are partially shown in FIG. 1.

Jigs 41, 42 are mounted on the ends 4a, 4b of the lock ring 4, respectively. The jigs 41, 42, in pairs, constitute the jig 40 for mounting/demounting the lock ring 4.

The jigs 41, 42, in a state shown in FIG. 1, are penetrated therethrough by a screw bolt 8. The jigs 41, 42 are provided with female screws 41h, 42h, formed so as to penetrate through the jigs 41, 42, respectively, although not clearly shown in the figure. And the screw bolt 8 is in mesh with the female screws (not shown) 41h, 42h, penetrating through the jigs 41, 42, respectively.

In FIG. 1, a clamp bolt 9 for securing the jigs 41, 42 is provided on respective upper parts of the jigs 41, 42.

The female screw 41h formed in the jig 41 is “inversely threaded” in orientation against the female screw 42h formed in the jig 42 although not clearly shown in the figure. Furthermore, a male screw 81 in a region of the screw bolt 8, penetrating through the jig 41, is also “inversely threaded” in orientation against a male screw 82 in a region of the screw bolt 8, penetrating through the jig 42.

Accordingly, upon turning the screw bolt 8 in one direction, the jigs 41, 42 are adapted to move in respective directions separating them further away from each other while upon turning the screw bolt 8 in a direction opposite from the one direction, the jigs 41, 42 are adapted to move in respective directions causing them to approach each other.

With the embodiment shown in the figures, the jig 40 is made up such that upon turning the screw bolt 8 counterclockwise, the jigs 41, 42 are moved so as to be further away from each other while upon turning the screw bolt 8 clockwise, the jigs 41, 42 are moved in respective directions so as to come closer to each other, as described later on with reference to FIGS. 10, and 15.

The jigs 41, 42 are constructed in such a way as to be basically bilaterally symmetrical to each other.

In FIG. 2, there is shown the jig 41 as a representative of the jigs 41, 42. The jig 41 is composed of a main block 41B and a clamp 41C. The main block 41B is formed integrally with the clamp 41C by, for example, welding and so forth. In this connection, the jig 42 (not shown in the figure) also has a main block, and a clamp. In the present specification, the main block of the jig 42 is not denoted by reference numeral “42B” in the figure, however, there may be a case where the main block of the jig 42 is referred to as “42B”. Similarly, a clamp of the jig 42 is not denoted by reference numeral “42C” in the figure, however, there may be a case where the clamp of the jig 42 is referred to as “420”.

The female screw (41h: refer to FIG. 1) penetrating through the jig 41B is formed in the bock 41B, and the clamp 41C holds an edge portion 4E of the lock ring 4 (an edge portion on the left-hand side in FIG. 2) interposed therein.

In FIG. 2, the clamp 41C as a whole is formed in a shape resembling the letter U, having an upper flange Cfu, and a lower flange Cfd.

A through-hole Cuh provided with a female screw is drilled in the upper flange Cfu. By causing the clamp bolt 9 to mesh with the female screw (not shown) of the through-hole Cuh to be then tightened up, it is possible to keep the clamp 41C in a state where the edge portion 4E of the lock ring 4 is interposed therein.

The lower flange Cfd is structured so as to have a tip Cfde in a wedge-like shape to thereby enable the tip Cfde to advance along a butting surface between the lock ring 4, and the gutter band 11.

In FIG. 2, reference numerals 4t and 11a will be described later on with reference to FIG. 11.

It is mainly in parts of double tires, where a rim 100J on the inner side thereof is opposed to the rim 100 on the outer side thereof, that is, regions being denoted by reference numerals C1, C2, respectively, in FIG. 3, that the ends 4a, 4b of the lock ring 4 are joined with each other with the use of the Jigs 41, 42 (as shown in FIGS. 1, and 2).

Next, a method for mounting the lock ring 4 on the rim 100 (or the gutter band 11) by use of the Jigs 41, 42, as shown in FIGS. 1, and 2, is described hereinafter with reference to FIGS. 4 to 18. A method for mounting the lock ring 4 on the rim 100J shown in FIG. 51 is the same as the method referred to as above.

In FIGS. 4 to 18, there is described a case of mounting the lock ring 4 in a region of the outer rim 100, on the inner side thereof, (that is, the region C1 in FIG. 3), as is evident by referring to FIGS. 11, and 12.

Firstly, if a lock ring exists as a single piece, the Jigs 41, 42 are placed in close proximity to respective end faces 4ae, 4be of the ends 4a, 4b of the lock ring 4, respectively, as shown in FIG. 4.

When the lock ring 4 is a single piece, the respective end faces 4ae, 4be, at a separation spot of the lock ring 4, are butted against each other by the agency of elastic repulsion force of the lock ring 4 itself (the elastic repulsion force tending to cause a decrease in dimension in the radial direction), as described in the foregoing.

As shown in FIG. 5, a dimension h1 between the upper flange Cfu, and the lower flange Cfd of the clamp 41C, or the clamp 42C, in the direction of height thereof, is set larger than a dimension (thickness) h2 in the direction of height of an edge portion 4E of the lock ring 4.

Accordingly, the edge portion 4E of the lock ring 4 can be easily inserted between the upper flange Cfu, and the lower flange Cfd of the clamp 41C, as shown in FIG. 6. Herein, in FIG. 5, only the clamp 41C of the jig 41 is shown, omitting the main block 41B for the sake of simplification in illustration.

With the jig 41 in a state shown in FIG. 7 (with the edge portion 4E of the lock ring 4 being in such a state as inserted between the flanges of the clamp), the clamp bolt 9 has not been tightened up as yet, and there exists a gap denoted by reference numeral δ between a bottom surface Cfus of the upper flange Cfu, and an upper surface 4Eu of the edge portion 4E of the lock ring 4.

Then, the clamp bolt 9 is tightened up into the jigs 41, 42, respectively, as shown in FIG. 8. By so doing, a lower end 9u of the clamp bolt 9 is butted against the upper surface 4Eu of the edge portion 4E of the lock ring 4, as shown in FIG. 9, thereby causing the jigs 41, 42 to be united with the ends 4a, 4b of the lock ring 4, respectively.

As shown in FIGS. 4, and 8, in this stage (a stage shown in FIG. 8), the lock ring ends 4a, 4b are butted against each other, and a distance L between respective end faces 4ae, 4be of the lock ring ends 4a, 4b (refer to FIG. 8) is zero.

Subsequently, in FIG. 10, the screw bolt 8 is turned by use of a rotary tool such as an impact wrench 50, a hexagonal wrench, spanner, and so forth.

As described in the foregoing, the female screw 41h formed in the jig 41 is “inversely threaded” in orientation against the female screw 42h formed in the jig 42, and the male screw 81 in the region of the screw bolt 8, penetrating through the jig 41, is also “inversely threaded” in orientation against the male screw 82 in the region thereof, penetrating through the jig 42.

With the embodiment of the invention, shown in FIG. 10, the screw bolt 8 is turned counterclockwise, in which case, the jigs 41, 42 are adapted to move in respective directions so as to be parted from each other. In a step shown in FIG. 10, the respective end faces 4ae, 4be of the lock ring ends 4a, 4b are parted from each other by the distance L as a result of the screw bolt 8 being turned counterclockwise.

More specifically, the distance L between the respective end faces 4ae, 4be of the lock ring ends 4a, 4b is set to such a distance as to enable a state as shown in FIG. 11 to be achieved.

As shown in FIGS. 11, and 12, when the jigs 41, 42 are secured to the respective ends 4a, 4b of the lock ring 4, the distance L between the respective end faces 4ae, 4be of the lock ring ends 4a, 4b is set to a distance where an inside diameter D1 of the lock ring 4, at the apex of a protrusion 4t, on the inside diameter side thereof, is larger than an outside diameter D2 of the gutter band 11, corresponding to the outermost diameter thereof. When the predetermined distance L is reached, the lock ring 4 is moved as far as the lock ring groove 11a of the gutter band 11 of a rim base 1 on which the lock ring 4 is to be mounted (movement indicated by the arrow K in FIGS. 11, and 12).

When the lock ring 4 is moved as far as above the lock ring groove 11a of the gutter band 11 (the lock ring 4 in a state shown in FIG. 12), the protrusion 4t in a region of the lock ring 4, above the gutter band 11 (the protrusion 4t protruding downward from the lock ring 4), is engaged with the lock ring groove 11a of the gutter band 11 (FIG. 13).

Upon engagement of the protrusion 4t of the lock ring 4, in an upper region thereof (in the direction of the arrow U in FIG. 13), with the lock ring groove 11a of the gutter band 11, the inside diameter ΦD1 of the lock ring 4 is larger than the outside diameter ΦD2 of the gutter band 11, so that a lower (in the direction of the arrow D in FIG. 14) region of the lock ring 4 is parted (downward) from the gutter band 11, as shown in FIG. 14.

With the lock ring 4 in a state shown in FIGS. 13, and 14, respectively, the screw bolt 8 is turned clockwise, thereby causing the distance L between the respective end faces 4ae, 4be of the lock ring ends 4a, 4b to be decreased (FIG. 15).

As a result, the lock ring 4 undergoes deformation along the whole circumference thereof in such a way as to be engaged with the lock ring groove 11a of the gutter band 11, as shown in FIG. 16. And a portion of the lock ring 4, in a lower region thereof, in FIG. 16 (on the arrow D side in FIG. 16), comes closer to the lock ring groove 11a, in a lower region of the lock ring, to be engaged therewith.

Then, the screw bolt 8 is turned clockwise until the lock ring 4 is engaged with the groove 11a, along the whole circumference of the lock ring 4, and the portion of the lock ring 4, in the lower region thereof, in FIG. 16, (on the arrow D side in FIG. 16) is engaged with the lock ring groove 11a, in the lower region of the lock ring, as shown in FIG. 17, thereby causing a decrease in the distance L between the respective end faces 4ae, 4be of the lock ring ends 4a, 4b.

Upon completion of engagement of the lock ring 4 with the groove 11a of the gutter band 11, along the whole circumference of the lock ring 4, the clamp bolts 9 each are loosened up, and the jig 40 (41, 42) is demounted from the lock ring ends 4a, 4b, respectively, as shown in FIG. 18.

The lock ring 4, in this state, is fitted into the lock ring groove 11a by the agency of the elastic repulsion force (resilience) of the lock ring 4 itself to be mounted thereon with certainty.

Next, there is described hereinafter a method for demounting the lock ring 4 mounted on the rim 100 (or the gutter band 11), using the jig 40 (41, 42), with reference to FIGS. 19 to 31.

As shown in FIG. 19, the jig 40 (41, 42: the jig 41 as the representative of the jig 40 is hereinafter referred to) is attached to the respective ends 4a, 4b of the lock ring 4, in order to remove the lock ring 4 fitted to the gutter band 11.

To attach the jig 41 to the end 4a, a blow is struck to the jig 41 by use of, for example, a hammer H, and so forth, as shown in FIG. 20, thereby causing the lower flange Cfd of the clamp 41C of the jig 41 to advance along a boundary (abutting surface) between the lock ring 4, and the gutter band 11.

Since the tip Cfde of the lower flange Cfd of the clamp 41C of the jig 41 is in a pointed shape, as shown in FIG. 21, upon striking a blow at the jig 41 with the use of a hammer H and so forth, the tip Cfde can easily advance along the boundary (the butting surface) between the lock ring 4, and the gutter band 11.

When the jig 41 is attached to the end 4a by causing the lower flange Cfd of the clamp 41C of the jig 41 to advance along the boundary (the butting surface) between the lock ring 4, and the gutter band 11, the clamp bolt 9 is tightened up, thereby fixing the jig 41 integrally with the end 4a of the lock ring 4, as shown FIG. 22, and FIG. 23 (a sectional arrow view taken on line X-X of FIG. 22), respectively.

Then, as shown in FIG. 24, the screw bolt 8 is turned counterclockwise to thereby cause the jigs 41, 42 to move so as to be further away from each other, adjusting such that a distance between the respective end faces 4ae, 4be of the lock ring ends 4a, 4b will reach the predetermined value L in length.

When the end face 4ae is parted from the end face 4be by the distance L, the inside diameter D1 of the lock ring 4, at the apex of the protrusion 4t of the lock ring 4, becomes larger in value than the outside diameter D2 of the gutter band 11, as shown in FIG. 25.

Further, as for an actual positional relationship between the lock ring 4, and the gutter band 11 at this point in time, in a lower side region (on the arrow D side in FIG. 26) of the lock ring 4, the protrusion 4t of the lock ring 4 is positioned below the gutter band 11, as shown in FIG. 26.

Subsequently, the lock ring 4, in a state shown in FIG. 26, is lifted to be thereby moved upward (toward the arrow U in FIG. 26).

Then, as shown in FIG. 27, the lock ring 4 is shifted such that the whole region of an inner peripheral surface (the inside diameter: ΦD1) of the protrusion 4t of the lock ring 4 is positioned on the outer side of the gutter band 11 (the outside diameter: ΦD2), in the radial direction thereof.

In the case of demounting the lock ring, a tire 6, a bead sheet band 3, and side rings 2 are joined with the rim base 1, as shown in FIG. 28. In such a case, it is necessary to reduce air pressure of the tire 6 to thereby cause the tire 6 to lean toward the left side (toward the arrow Y in FIG. 28) of a broken line shown in FIG. 28.

The reason for this is because unless the tire 6 is caused to lean toward the left side, as shown in FIG. 28, there is a possibility that the lock ring 4 will interfere with the tire 6, the bead sheet band 3, and the side rings 2 when the lock ring 4 is disposed such that the whole region of the inner peripheral surface (the inside diameter: ΦD1) of the lock ring 4 is positioned on the outer side of the gutter band 11 (the outside diameter: ΦD2), in the radial direction thereof (refer to FIG. 27).

Then, as shown in FIG. 29, the lock ring 4 is slid toward an outer side of the rim (the gutter band 11) (an outer side of a vehicle) to be thereby removed from the rim base 1.

Herein, FIG. 29 shows the case of removing a lock ring (a lock ring installed in the region C2 in FIG. 3) on the inner side (the left-hand side in FIG. 29) of double tires. For simplification in illustration, tires are omitted in FIG. 29.

In FIG. 30, after the lock ring 4 is removed from the rim base 1 (the gutter band 11), the screw bolt 8 is turned clockwise such that a width (width denoted by L) between the end faces 4ae, 4be of the lock ring 4 becomes smaller. Subsequently, the end faces 4ae, 4be are finally butted against each other, as shown in FIG. 31.

Then, the clamp bolt 9 is loosened, thereby releasing the clamps 41C, 42C. Upon release of the clamps 41C, 42C, the jig 40 is completely disengaged from the lock ring 4.

Now, with the first embodiment of the invention, described with reference to FIGS. 1 to 31, the male screw 81 in the region of the screw bolt 8, penetrating through the jig 41, is “inversely threaded” in orientation against the male screw 82 in the region of the screw bolt 8, penetrating through the jig 42. And the jigs 41, 42 are made up such that an interval between the two jigs 41, 42 is either stretched or shrunk by turning the screw bolt 8.

However, as is the case of a first variation shown in FIG. 32, there may be adopted a construction wherein a screw bolt 8A is provided with a male screw 80 having screw threads oriented in an identical direction only, either a jig 411, or a jig 412 (the jig 411 on the right side in FIG. 32) is fixed, the axial direction of the screw bolt 8A is fixed, a female screw (not shown in FIG. 32) is formed in the other jig (the jig 412 on the left side in FIG. 32), and only the jig 412 is in mesh with the screw bolt 8A so as to be movable.

Otherwise, as is the case of a second variation shown in FIG. 33, jigs 421, 422 are attached to a cylinder mechanism 430 (for example, a small sized hydraulic cylinder mechanism), and it is possible to increase an interval between the jigs 421, 422 by causing the cylinder mechanism 430 to expand or to decrease the interval therebetween by causing the cylinder mechanism 430 to retract.

The first variation shown in FIG. 32, and the second variation shown in FIG. 33 are the same in respect of construction in other respects, and operation effect as the first embodiment described with reference to FIGS. 1 to 31.

Next, there is described hereinafter a second embodiment of the invention with reference to FIGS. 34 to 39.

FIG. 34 shows the overview of the first embodiment described with reference to FIGS. 1 to 33. In FIG. 34, there is described the case where the screw bolt 8 is turned counterclockwise, thereby causing the jigs 41, 42 to be parted from each other.

It has been found out on the basis of an experiment conducted by the inventor that when the jigs 41, 42 are parted from each other, the inside diameter of the lock ring 4 is not evenly increased in size, so that an inside diameter of the lock ring, denoted by ΦA in FIG. 34, tends to be smaller than an inside diameter of the lock ring, denoted by ΦB (ΦB>ΦA). That is, there is a tendency that the lock ring 4, on the inside diameter side thereof, tends to be in the shape of a warped ellipse rather than a perfect circle.

When the lock ring 4, on the inside diameter side thereof, is in the shape of the warped ellipse rather than the perfect circle, even if the interval between the jigs 41, 42 is stretched, the inside diameter ΦD1 of the lock ring 4, along the whole circumference thereof, will not become larger in value than the outside diameter ΦD2 of the gutter band 11, so that it is not possible to move the jig 40 to an adequate position above the gutter band 11 (not shown in FIG. 34). Accordingly, the interval between the jigs 41, 42 should be further stretched.

The reason why the lock ring 4, on the inside diameter side thereof, is not expanded in diameter by maintaining the shape of a perfect circle even if the interval between the jigs 41, 42 is stretched is because bending moments applied to the lock ring 4 by the jigs 41, 42, respectively, are proportional to respective distances from the jig 41, or the jig 42 to each part of the lock ring 4 when the distance between the respective end faces 4ae, 4be of the lock ring 4 is increased by stretching the interval between the jigs 41, 42.

In FIG. 34, the jigs 41, 42, being in mesh with the screw bolt 8, will not undergo a relative movement against the respective ends of the lock ring 4. It therefore follows that a given angle (right angle) (in FIG. 34, there is shown an angle between orientation AR1 of the end 41T of the jig 41 only, and the direction A8L of the center axis of the screw bolt 8) is always maintained between an end 41T of the jig 41, or an end 42T of the jig 42, and a direction A8L of the center axis of the screw bolt 8.

In the case of further increasing the interval between the jigs 41, 42, the jigs 41, 42 being in mesh with the screw bolt 8, as shown in FIG. 34, the angle between the orientation AR1 of the end 41T of the jig 41, and the direction A8L of the center axis of the screw bolt 8 becomes constant (the right angle), remaining unchanged. Accordingly, the lock ring 4 undergoes deformation such that curvature of parts of the lock ring 4, in close proximity to spots where the jigs 41, 42 are fixed to the lock ring 4, will become smaller. Because of such variation in curvature, the lock ring 4, on the inside diameter side thereof, cannot be kept in the sate of a perfect circle when the interval between the jigs 41, 42 is stretched.

A second embodiment of the invention has been proposed to solve the problem described in the foregoing.

FIG. 35 shows the overview of the second embodiment of the invention.

As shown in FIG. 35, with the second embodiment of the invention, jigs 410, 420, fixedly attached to respective ends of a lock ring 4, are made up such that angles (in FIG. 35, an angle θ is shown byway of example) which respective ends 410T, 420T of the jigs 410, 420 form with a center axis A8L of a screw bolt 8 are freely variable.

Accordingly, in FIG. 35, although the screw bolt 8 is in mesh with the jigs 410, 420, respectively, as an interval AL between the jigs 410, 420 becomes ether wider, or narrower, so the angles which the respective ends 41T, 42T form with the center axis A8L are gradually changed. Then, occurrence of abrupt variation in curvature at parts of the lock ring 4, in close proximity to the jigs 410, 420, respectively, is prevented.

As a result, a direction (the direction of the arrow A4ae) of the tangent at the end of the lock ring 4 is always maintained at right angles to the radial direction connecting the center of the lock ring 4, on the inside diameter side thereof, to the end of the lock ring 4, so that the lock ring 4, on the inside diameter side thereof, can be kept in the state of a perfect circle in shape (in FIG. 35, a perfect circle with an inside diameter φC) with greater ease.

Referring to FIGS. 36 to 38, there is described hereinafter a construction for enabling the angles which the respective ends 410T, 420T of the jigs 410, 420 form with the center axis A8L of the screw bolt 8 to be variable. In FIGS. 37 and 38, only the jig 410 is shown.

In FIGS. 36 and 37, in the case of the jigs 410, 420, respective components corresponding the main block and the clamp, in the jigs 41, 42, and 411, 412, respectively, referred to in any of FIGS. 1 to 33, are a block 432, and two clamp members 434, 436, with the block 432 sandwiched therebetween.

As shown in FIGS. 37 and 38, a female screw 438 is formed in the block 432 so as to penetrate therethrough. Further, in FIGS. 37 and 38, there is shown a state of the screw bolt 8 being in mesh with the female screw 438 penetrating through the block 432 to be inserted therein.

As is evident from FIG. 37, the block 432 is provided integrally with shafts 440, 442.

The shafts 440, 442 each are extended in a direction orthogonal to the screw bolt 8. In other words, the shafts 440, 442 each are extended so as to cross the axial direction of the female screw 438 penetrating through the block 432, at right angles.

The clamp member 434 has a long hole 446 penetrating therethrough, and the clamp member 436 has a long hole 448 penetrating therethrough. And the shaft 440 is inserted into the long hole 446, and the shaft 442 is inserted into the long hole 448.

The long holes 446, 448 each are formed so as to have a major axis in the radial direction of the lock ring 4, that is, in the direction indicated by the arrow R in FIG. 36. The shafts 440, 442 are freely rotatable within the long holes 446, 448, respectively, and freely movable in the radial direction of the lock ring 4.

A through-hole 450 is provided in the clamp members 434, 436, respectively, and a female screw is formed in the through-hole 450 of the clamp member 436.

In FIGS. 36 to 38, a bolt 452 (in FIG. 37, indicated by a dash and dotted line; in FIG. 38, a direction in which the same is tightened up is indicated by the arrows 4521 in pairs) is inserted into the respective through-holes 450, and is in mesh therewith, so that the clamp members 434, 436 are joined integrally with each other, the block 432 being sandwiched therebetween by tightening the bolt 452 up.

As shown in FIG. 38, since respective ends 434E, 436E of the clamp members 434, 436, on a side thereof, adjacent to the lock ring, are each formed in a clamp-like shape, the ends 434E, 436E of the clamp are engaged with each other so as to be secured together in such a way as to clamp the lock ring 4 if the clamp members 434, 436 are squeezed by tightening up the bolt 452 as indicated by the arrows 4521. In so doing, the block 432, the clamp members 434, 436, and the lock ring 4 are integrally fixed to each other.

With adoption of the construction shown in FIGS. 36 to 38, the screw bolt 8 is in mesh with the female screw 438 penetrating through the block 432, so that the same operation effect as that of the embodiments described with reference to FIGS. 1 to 34, respectively, can be exhibited.

In addition, since the shafts 440, 442 of the block 432 are inserted into the long holes 446, 448, respectively, even if there occurs a slight increase or decrease in the interval between the clamp members 434, 436, and the clamp members 434, 436 are not in parallel with each other, the angle θ in FIG. 35 is freely variable because the shafts 440, 442 are rotatable within the long holes 446, 448, respectively, and freely movable in the radial direction of the lock ring 4. For this reason, occurrence of small variation in curvature at parts of the lock ring 4, in regions in close proximity to the jigs 410, 420, respectively, is prevented.

In other words, even if there occurs an increase or a decrease in the inside diameter of the lock ring 4 (FIG. 35, the inside diameter φC) due to an increase or a decrease in the interval ΔL between the jigs 410, 420, variation in respect of the interval ΔL, the inside diameter φC, and the angle θ will be absorbed by the long holes 446, 448, respectively. As a result, even if there occurs variation in the interval ΔL between the jigs 410, 420, the lock ring 4, on the inside diameter side thereof, can be kept in the state of a perfect circle in shape with greater ease.

With the second embodiment described as above with reference to FIGS. 36 to 38, the long hole 446 is penetrated through the clamp member 434, the long hole 448 is penetrated through the clamp member 436, and the long holes 446, 448 each are formed so as to have the major axis in the radial direction of the lock ring 4, that is, in the direction indicated by the arrow R in FIG. 36, as described in the foregoing. However, as shown in FIG. 39, in place of the long holes 446, 448, use may be made of openings 446C, 448C, circular in cross section, formed in the clamp members 434, 436, respectively. And the shafts 440, 442 are freely rotatable, and freely movable within the openings 446C, 448C, circular in cross section, respectively.

Further, respective cross-sectional shapes of the openings (through-holes) formed in the clamp members 434, 436, respectively, are not limited to an ellipse (a long hole), and a perfect circle, but openings having other cross-sectional shapes may be formed.

The second embodiment of the invention described with reference to FIGS. 34 to 39 is the same in respect of construction in other respects, and operation effect as the first embodiment described with reference to FIGS. 1 to 33.

FIG. 40 shows a third embodiment of the invention. In a region of FIG. 40, denoted by reference numeral A32, the third embodiment is the same in construction as the second embodiment described with reference to FIGS. 34 to 39. More specifically, the jigs 410, 420 described with FIGS. 34 to 39 are fixedly attached to the respective ends of the lock ring 4, and the screw bolt is in mesh with the jigs 410, 420.

In addition, the lock ring 4 of FIG. 40 is surrounded by a frame 500 resembling the letter U in cross section. A protrusion 510 is formed on each arm portion 502 of the frame 500. As shown in FIG. 40, the lock ring 4 is enveloped by the frame 500 such that the arm portions 502 each cross the direction of an inside diameter φB of the lock ring 4 at right angles. In this case, a bottom part of the frame 500, in FIG. 40, is open, and the lock ring 4 is covered (enveloped) by first bringing an open part of the frame 500 above the lock ring 4.

With the third embodiment shown in FIG. 40, if the lock ring 4 is not deformed into the shape of a perfect circle when an interval between the jigs 410, 420 is stretched, exhibiting a tendency that the inside diameter φB becomes greater than an inside diameter φA, the protrusions 510 disposed on the arm portions 502, respectively, come to be butted against an outer periphery of the lock ring 4, so that it is possible to stop the inside diameter φB of the lock ring 4 from increasing further in size, thereby stopping the lock ring 4 from being deformed into the shape of a warped ellipse.

If the interval between the jigs 410, 420 is stretched with the lock ring 4 kept in such a state, the lock ring 4 is increased in diameter in the direction of the inside diameter φA only, so that the lock ring 4 can be kept in the shape of a perfect circle.

In FIG. 40, the inside diameter φB of the lock ring 4 is checked from increasing in size by the action of the protrusions 510, thereby stopping the lock ring 4 from being deformed into the shape of the warped ellipse, however, the lock ring 4 can be stopped from being deformed into the shape of the warped ellipse by use of another construction. The inside diameter φB of the lock ring 4 may be checked from increasing in size, for example, by structuring the protrusion 510 disposed on each of the arm portions 502 of the frame 500 such that a protruding amount thereof is adjustable with the use of a screw structure, thereby enabling the lock ring 4 to be stopped from being deformed into the shape of the warped ellipse. Otherwise, the inside diameter φB of the lock ring 4 may be checked from increasing in size by structuring such that the arm portions 502 each come to be butted against the outer periphery of the lock ring 4, thereby stopping the lock ring 4 from being deformed into the shape of the warped ellipse.

The third embodiment of the invention described with reference to FIG. 40 is the same in respect of construction in other respects, and operation effect as the respective embodiments described with reference to FIGS. 1 to 39.

Further, with the third embodiment of the invention, if the jig 411, 412, shown in FIG. 32, or the jigs 421, 422, shown in FIG. 33, are used in place of the jigs 410, 420 shown in FIG. 40, this will eliminate the necessity of using the screw bolt 8 having the inversely threaded male screws.

FIGS. 41 to 43 each show a fourth embodiment of the invention.

As is the case with the third embodiment, with the fourth embodiment of the invention, a lock ring 4 is prevented from being deformed into the shape of a warped ellipse when an interval between jigs is stretched, thereby exhibiting a function for keeping the lock ring 4 in the state of an approximately perfect circle.

In FIG. 41, a bar-like member 470 is disposed along a direction of the tangent of the lock ring 4, and above respective ends 4a, 4b of the lock ring 4. More particularly, the bar-like member 470 is formed in such a way as to cross a center line Lc (a center line extending in the vertical direction in FIG. 41) of the lock ring 4 at right angles, so as to be symmetrical with respect to the center line Lc.

Jigs 460, 462, engaged with the respective ends 4a, 4b of the lock ring 4, comprise the same clamp members as those described with reference to FIGS. 36 to 38 (not shown, the same as the clamp members denoted by reference numerals 434, 436, respectively, in FIG. 37).

In FIGS. 41, and 42, the jigs 460, 462 each have a rotating shaft 470S provided in close proximity to an end of each of the jigs 460, 462, on a side thereof, opposite from an end thereof, engaged with the lock ring 4, and the rotating shaft 470S is housed in a long hole 470H formed in the bar-like member 470 so as to be supported movably and rotatably within the long hole 470H. The rotating shaft 470S, and the long hole 470H make up an axial support 470J that can support the jigs 460, 462, respectively, by rotatably reciprocating against the bar-like member 470, and moving in the longitudinal direction of the bar-like member 470.

Provided in close proximity of respective ends of the bar-like member 470, in the transverse direction thereof, are butting members 480, 482, which cross the bar-like member 470 at right angles, being extended downward therefrom. Further, the butting members 480, 482 each may be extended toward the center of the lock ring 4. The butting members 480, 482 each have a lower end butted against the outer peripheral surface of the lock ring 4. Furthermore, for the butting members 480, 482, a bolt structure may be adopted, and the butting members 480, 482 each may be constructed such that an amount of protrusion (a length of a portion of each butting member, extended downward in FIGS. 41, 42) is adjustable.

FIG. 41 shows a state of the fourth embodiment of the invention, wherein a screw bolt 8 is turned counterclockwise, thereby causing respective ends of the lock ring 4 to approach each other. The lock ring 4 in that state is indicated by a solid line A in FIG. 43.

On the other hand, in FIG. 42, there is shown a state of the fourth embodiment of the invention, wherein the screw bolt 8 is turned clockwise, thereby causing the respective ends of the lock ring 4 to be away from each other. In this state where the respective ends 4a, 4b of the lock ring 4 are away from each other (the state shown in FIG. 42), on the assumption that the butting members 480, 482 do not exist, the lock ring 4 is deformed into the shape of a warped ellipse having a major axis along the transverse axis (the horizontal axis in FIG. 43), as indicated by a dotted line B in FIG. 43.

When the ends 4a, 4b of the lock ring 4 are parted from each other, no bending moment is acting in regions in close proximity to the respective ends 4a, 4b, so that a curvature radius in the regions in close proximity to the respective ends 4a, 4b becomes smaller, and the lock ring 4 will be deformed into a shape other than a perfect circle although this is not clearly shown by the dotted line B in FIG. 43.

In contrast, with the fourth embodiment of the invention, the butting members 480, 482 each are butted against the outer periphery of the lock ring 4 to thereby press down the outer periphery as shown in FIG. 42.

Accordingly, when the respective ends 4a, 4b of the lock ring 4 are parted from each other with the lock ring 4 in a state shown in FIG. 42, portions of the lock ring 4, in neighborhood of spots where the lock ring 4 is butted against the butting members 480, 482, are expanded outward in the radial direction, whereupon a curvature radius is increased. As a result, the outer periphery of the lock ring 4 in whole is kept substantially in the shape of a perfect circle, as indicated by a broken line C in FIG. 43.

The fourth embodiment of the invention described with reference to FIGS. 41 to 43 is the same in respect of construction in other respects, and operation effect as the respective embodiments described with reference to FIGS. 1 to 40.

Further, as described above, with the fourth embodiment, use is made of a flaring mechanism 460, 462, similar to the jigs 410, 420 of the second embodiment described with reference to FIGS. 35 to 39, however, use can be made of the jigs according to the first embodiment described with reference to FIGS. 1 to 33. If use is made of the jigs according to the variations, described with reference to FIGS. 32, 33, in particular, it is possible to cause the respective ends of the lock ring 4 to part from each other without use of screws inversely threaded against each other.

FIGS. 44 to 46 each show a fifth embodiment of the invention. With the fifth embodiment as well, there is exhibited a function for keeping a lock ring 4 substantially in the shape of a perfect circle without causing lock ring 4 to be deformed into the shape of a warped ellipse when an interval between jigs is stretched.

In FIG. 44, jigs 410, 420 are engaged with respective ends 4a, 4b of a lock ring 4, and a flare-suppressor member 495 is provided at a spot of the lock ring 4, on a side thereof, opposite from the respective ends 4a, 4b, with which the jigs 410, 420 are engaged, in the circumferential direction of the lock ring 4.

As shown in FIG. 45, the flare-suppressor member 495 comprises a pair of clamps 495A, 495B, and a bolt B for integrally joining the clamps 495A, 495B with each other, and when the bolt B is tightened up, the lock ring 4 is tightened up by the clamps 495A, 495B, whereupon the flare-suppressor member 495 is fixed to a predetermined position (for example, a position shown in FIG. 44) on the lock ring 4.

In FIG. 46 showing a sectional arrow view of the flare-suppressor member 495, taken on line X-X of FIG. 45, an inside diameter at a contact face 495c between an inner side of the clamp 495A (495B), in the radial direction, and the lock ring, is set identical in dimension to an inside diameter of the inner peripheral surface of the lock ring 4, except for the protrusion 4t of the lock ring 4.

On the other hand, a clearance h3 between the contact face 495c between the inner side of the clamp 495A (495B), in the radial direction, and the lock ring, and a contact face 495d between an outer side of the clamp 495A (495B), in the radial direction, and the lock ring, is set slightly greater than a dimension h2 of the lock ring 4, in the direction of height, except for the protrusion 4t, so as to enable the lock ring 4 to enter the clearance h3 without a problem.

By setting the respective contact faces 495c, 495d of the flare-suppressor member 495, in contact with the lock ring, in such a way as described above, it is possible to suppress occurrence of localized increase in rigidity of the lock ring 4 by the action of the flare-suppressor member 495 when flaring of the lock ring 4 is executed by increasing the interval between the jigs 410, 420, thereby checking curvature radiuses of regions of the lock ring 4, engaged with the flare-suppressor member 495, from increasing in dimension.

With the flare-suppressor member 495, the longer a length L in the transverse direction in FIG. 44, the greater is restraint obtained by the flare-suppressor member 495 when the flaring of the lock ring 4 is executed. However, if the length L of the flare-suppressor member 495, in the transverse direction, is excessively large, this will render the flare-suppressor member 495 itself heavier, so that it becomes difficult to handle the same. Furthermore, in such a case, even the flaring of the lock ring 4, necessary for mounting/demounting of the lock ring 4, will be restrained, so that attention should be given thereto.

In FIGS. 44 to 46, only one unit of the flare-suppressor member 495 is provided, and is fixed to a position (at the bottom in FIG. 44: the position on a side of the lock ring 4, opposite from the jigs 410, 420) where a curvature radius is most susceptible to a change.

The fifth embodiment of the invention described with reference to FIGS. 44 to 46 is the same in respect of construction in other respects, and operation effect as the respective embodiments described with reference to FIGS. 1 to 43.

Further, as previously described, with the fifth embodiment, use is made of the jigs 410, 420 of the second embodiment described with reference to FIGS. 35 to 39, however, use can be made of the jigs according to the first embodiment described with reference to FIGS. 1 to 33. If use is made of the jigs described with reference to FIGS. 32, 33, in particular, it is possible to eliminate the use of the screws inversely threaded against each other.

FIGS. 47, and 48 each show a sixth embodiment of the invention. With the sixth embodiment as well, there is exhibited a function for keeping a lock ring 4 substantially in the shape of a perfect circle without causing the lock ring 4 to be deformed into the shape of a warped ellipse when an interval between jigs is stretched.

With the sixth embodiment of the invention, shown in FIGS. 47, and 48, the lock ring 4 is varied in cross-sectional shape according to a region thereof, in the circumferential direction of the lock ring 4, as shown in FIG. 48 (cross-section along line A-A, cross-section along line B-B, cross-section along line C-C). In FIG. 48, the cross-section along line A-A, the cross-section along line B-B are denoted by regions (48-1), (48-2), respectively, and in those regions, cutoff parts 4c1, 4c2 are provided, respectively. And the cutoff part 4c1 shown in the region (48-1) is formed so as to be larger in size than the cutoff part 4c2 shown in region (48-2). The cross-section along line C-C) shown in a region (48-3) is not provided with a cutoff part.

With the sixth embodiment of the invention, shown in FIGS. 47, and 48, when an interval between respective end faces 4a, 4b of the lock ring 4 is stretched, sectional secondary moment (rigidity) of the lock ring 4 is reduced in a region in the circumferential direction of the lock ring 4, where bending moment is not largely acting.

In so doing, upon stretching of the interval between the respective ends of the lock ring 4, respective curvatures of regions corresponding to the cross-section A-A, and the cross-section B-B, respectively, are increased, thereby suppressing the lock ring 4 from being deformed into the shape of a warped ellipse.

Now, contrary to the case described as above with reference to FIG. 48, the sectional secondary moment (rigidity) of the lock ring 4 may be increased in a region of the lock ring 4, in the circumferential direction thereof, where bending moment is largely acting, thereby suppressing the lock ring 4 from being deformed into the shape of a warped ellipse.

FIGS. 49, 50 each show a variation of the sixth embodiment of the invention, shown in FIGS. 47, and 48, the variation being based on such a concept.

With the variation of the sixth embodiment, shown in FIG. 49, a reinforcement member 4F having inclined surfaces bilaterally symmetrical to each other as shown in FIG. 49 is formed in a region (at the bottom part of the lock ring 4, in FIG. 49) of the lock ring 4, on a side thereof, opposite from the respective ends of the lock ring 4, and the lock ring 4 is made up such that a part thereof, along line X-X (at the center of the reinforcement member 4F), has the largest wall thickness.

As shown in FIG. 50, the reinforcement member 4F having the inclined surfaces bilaterally symmetrical to each other as shown in FIG. 49 is fixedly attached to the lock ring 4 by use of a weld 4FW provided at respective ends of the reinforcement member 4F.

With the variation of the sixth embodiment, shown in FIG. 49, 50, the lock ring 4 is formed such that the sectional secondary moment (rigidity) of the lock ring 4 is increased in the region of the lock ring 4 (at the bottom part of the lock ring 4, in FIG. 47) in the circumferential direction thereof, where the bending moment is largely acting, thereby suppressing bending deformation in the region, so that the lock ring 4 is prevented from being deformed into the shape of a warped ellipse when the interval between the respective ends of the lock ring 4 is stretched.

The sixth embodiment of the invention described with reference to FIGS. 47 to 50 is the same in respect of construction in other respects, and operation effect as the respective embodiments described with reference to FIGS. 1 to 46.

Now, with the sixth embodiment, use is made of the jigs 410, 420 of the second embodiment described with reference to FIGS. 35 to 39, however, use can be made of the jigs according to the first embodiment described with reference to FIGS. 1 to 33. If use is made of the jigs described with reference to FIGS. 32, 33, in particular, it is possible to eliminate the use of the screws inversely threaded against each other.

Having described the embodiments with reference to various drawings, it is to be pointed out that those embodiments are described for illustrative purposes only and changes and variations may be made in the invention without departing from the spirit and scope thereof.

For example, the present invention described in the foregoing is applicable to not only a wheel provided with a disc but also a rim without a disc attached thereto.

Further, the present invention is applicable to not only the case of a double tires but also the case of a single tire provided that use is made of the “one piece” lock ring. Furthermore, the present invention is applicable to not only a rim of a front wheel but also a rim of a rear wheel.

### BRIEF DESCRIPTION OF THE DRAWINGS

FIG. 1 is a front view showing the principal part of a first embodiment of the invention.

FIG. 2 is an enlarged sectional view from arrow B in FIG. 1.

FIG. 3 is a view of components showing regions where ends of a lock ring are joined with each other with the use of the embodiment of the invention shown in FIGS. 1, and 2.

FIG. 4 is a front view showing jigs as mounted on the respective ends of the lock ring.

FIG. 5 is a schematic representation showing a difference in dimension between the thickness of an edge portion of the lock ring, and an interval between an upper flange, and a lower flange of a clamp.

FIG. 6 is a side view showing a state where the edge portion of the lock ring is inserted between the upper flange, and the lower flange of the clamp.

FIG. 7 is a partially enlarged view showing a relative positional relation between the edge portion of the lock ring and the upper flange of the clamp in FIG. 6.

FIG. 8 is a front view showing the step of tightening up a clamp bolt.

FIG. 9 is a partially enlarged side view showing the clamp bolt in as-tightened state.

FIG. 10 is a front view showing the step of stretching an interval between the respective ends of the lock ring by turning a screw bolt.

FIG. 11 is a side view showing a relation in dimension between an inside diameter of the lock ring, and an outside diameter of a gutter band when the interval between the respective ends of the lock ring is stretched.

FIG. 12 is a side view showing a state of the lock ring moved as far as above the groove of the gutter band.

FIG. 13 is a side view showing a state of the lock ring with the jig mounted thereon, being engaged with the groove of the gutter band.

FIG. 14 is a side view showing a general positional relation between the lock ring, and the gutter band, in a state shown in FIG. 13, respectively.

FIG. 15 is a front view showing the step of decreasing the interval between the respective ends of the lock ring, in a state shown in FIG. 13.

FIG. 16 is a side view showing a general positional relation between the lock ring, and the gutter band, in a state shown in FIG. 15, respectively.

FIG. 17 is a side view showing a state in which a portion of the lock ring, on a side thereof, opposite from a portion of the lock ring, with the jigs mounted thereon, is engaged with the groove of the gutter band as a result of a decrease in distance between the respective ends of the lock ring.

FIG. 18 is a side view showing a state in which the jig is demounted from the end of the lock ring, thereby completing fitting of the lock ring.

FIG. 19 is a front view showing the respective ends of the lock ring to be removed from the gutter band.

FIG. 20 is a view showing the step of causing the lower flange of the clamp of the jig to advance along a boundary surface between the lock ring, and the gutter band.

FIG. 21 is an enlarged view of the lower flange of the clamp of the jig.

FIG. 22 is a front view showing the step of tightened up a clamp bolt of the jig.

FIG. 23 is a side view showing the step shown in FIG. 22.

FIG. 24 is a front view showing the step of stretching an interval between the respective ends of the lock ring by turning the screw bolt.

FIG. 25 is a side view showing a relation in dimension between an inside diameter of the lock ring, and an outside diameter of the gutter band when the interval between the respective ends of the lock ring is stretched.

FIG. 26 is a side view showing a general positional relation between the lock ring, and the gutter band, in a state shown in FIG. 25, respectively.

FIG. 27 is a view showing the step of causing the lock ring to be shifted such that the whole region thereof is positioned on the outer side of the gutter band.

FIG. 28 is a view showing a state in which a tire is caused to lean toward one side in order to prevent the lock ring from interfering with the tire, a bead sheet band, and side rings at the time of executing the step of FIG. 27.

FIG. 29 is a view showing the step of sliding the lock ring, thereby removing the same from the rim base.

FIG. 30 is a view showing the step of joining the respective ends of the lock ring with each other.

FIG. 31 is a view showing the step of disengaging the jigs from the respective ends of the lock ring.

FIG. 32 is a front view showing the principal part of a first variation of the first embodiment of the invention.

FIG. 33 is a front view showing the principal part of a second variation of the first embodiment of the invention.

FIG. 34 is view showing the overview of the first embodiment, exhibited for the purpose of explanation about improvement made in a second embodiment.

FIG. 35 is a front view showing the second embodiment of the invention.

FIG. 36 is a front view showing the principal part of the second embodiment of the invention.

FIG. 37 is an enlarged partly exploded view of a jig according to the second embodiment.

FIG. 38 is an enlarged partly exploded view showing a relation between the jig and a lock ring, according to the second embodiment.

FIG. 39 is a front view showing the principal part of a variation of the second embodiment of the invention.

FIG. 40 is a front sectional view showing a third embodiment of the invention.

FIG. 41 is a front view showing a fourth embodiment of the invention.

FIG. 42 is a front view of the fourth embodiment, showing a state where an interval between respective ends of a lock ring is stretched.

FIG. 43 is a schematic diagram showing a state of the lock ring before the interval between respective ends of the lock ring is stretched, a state of the lock ring when the interval between respective ends of the lock ring is stretched without the fourth embodiment of the invention, applied thereto, and a state of the lock ring when the interval between respective ends of the lock ring is stretched with the fourth embodiment of the invention, applied thereto, for the purpose of comparison among them.

FIG. 44 is a front view showing a fifth embodiment of the invention.

FIG. 45 is an enlarged sectional view taken on line A-A of FIG. 44.

FIG. 46 is an enlarged sectional view from arrow B, taken on line X-X in FIG. 45.

FIG. 47 is a front view showing a sixth embodiment of the invention.

FIG. 48 is a partial sectional view of the sixth embodiment shown in FIG. 47.

FIG. 49 is a partially enlarged front view showing the principal part of a variation of the sixth embodiment.

FIG. 50 is a sectional arrow view taken on line C-C of FIG. 49.

FIG. 51 is a sectional view of a conventional multi-piece rim.

FIG. 52 is a view showing a lock ring as a single component of FIG. 51.

FIG. 53 is a sectional view showing a construction of double tires in the background art.

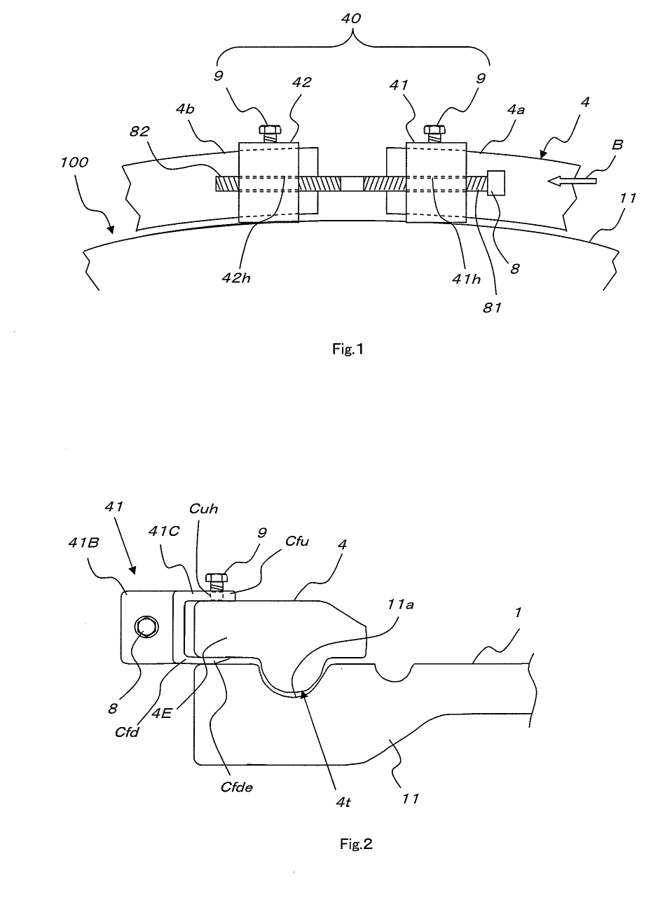

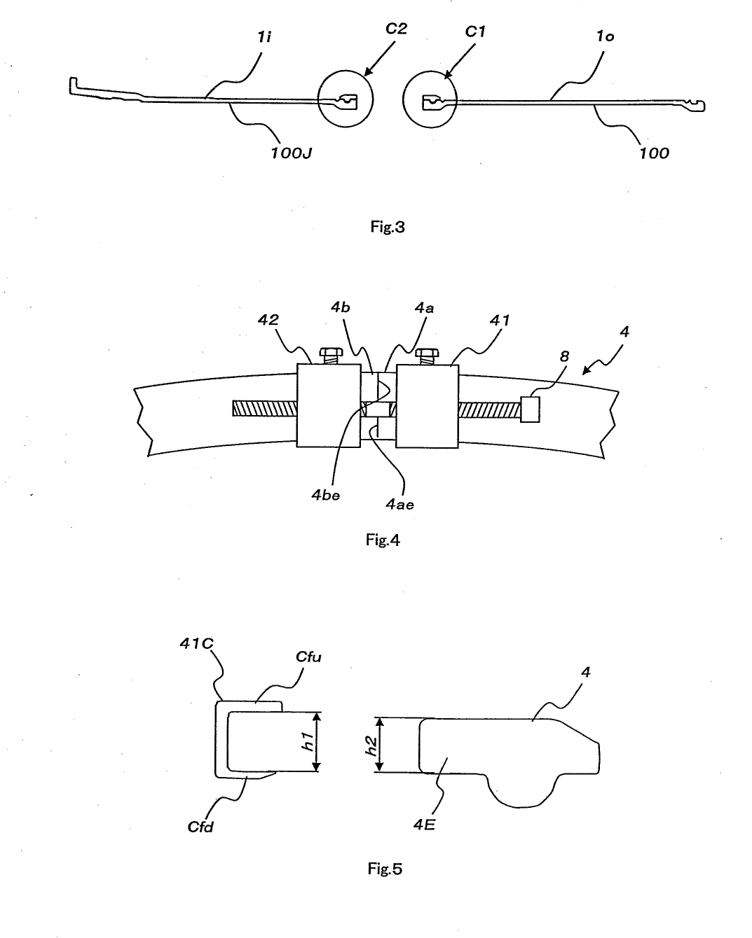

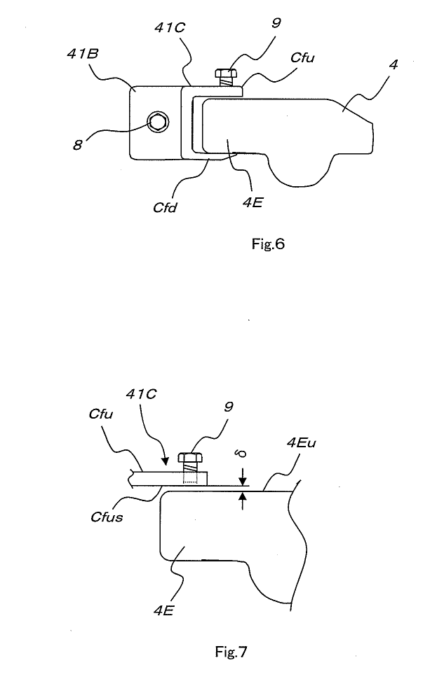

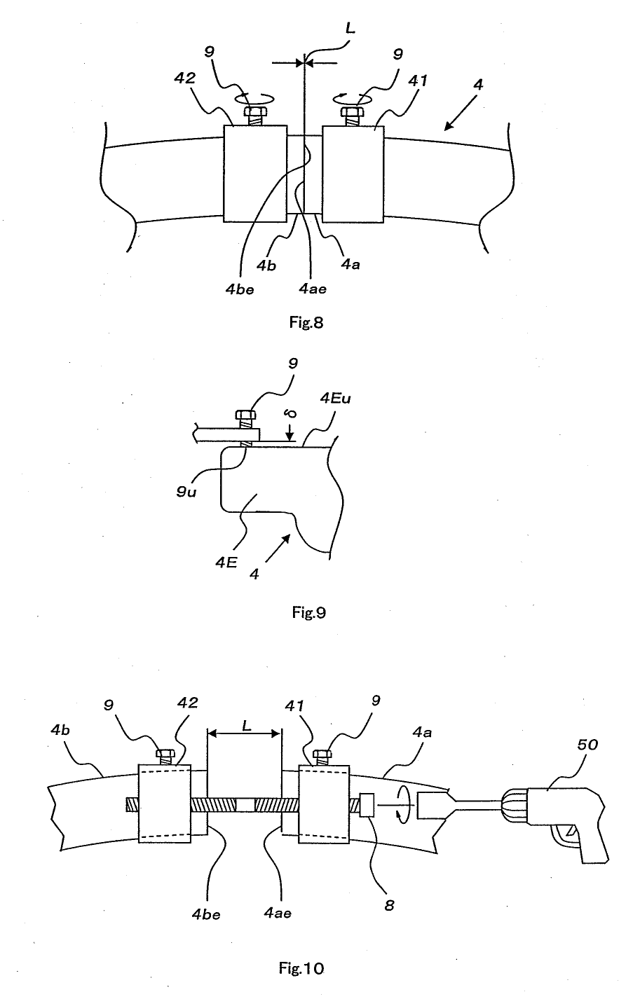

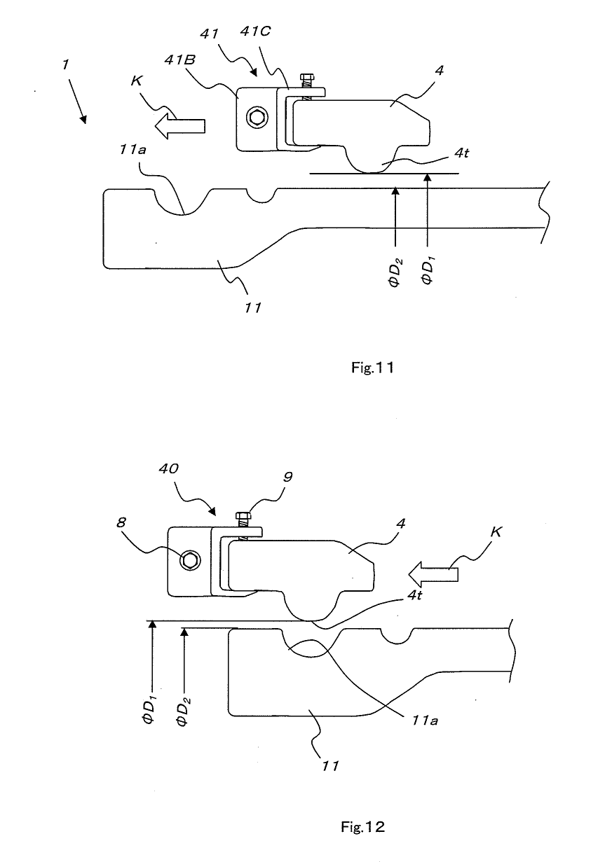

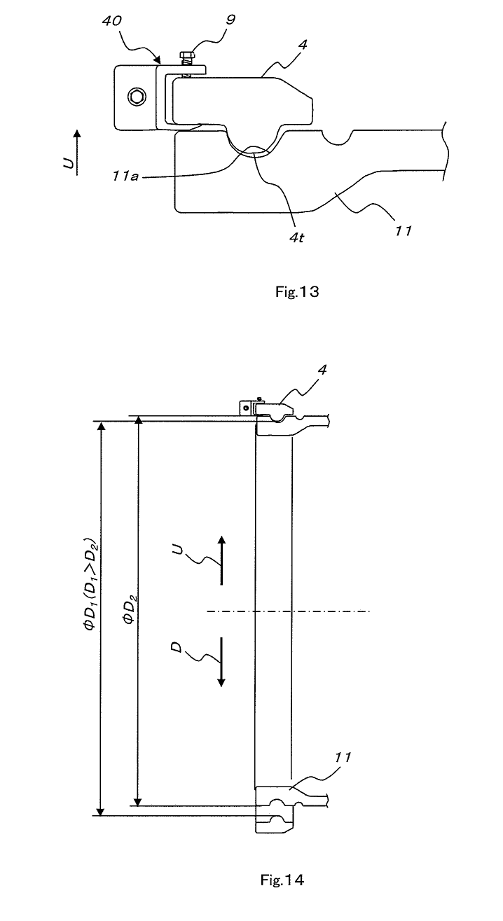

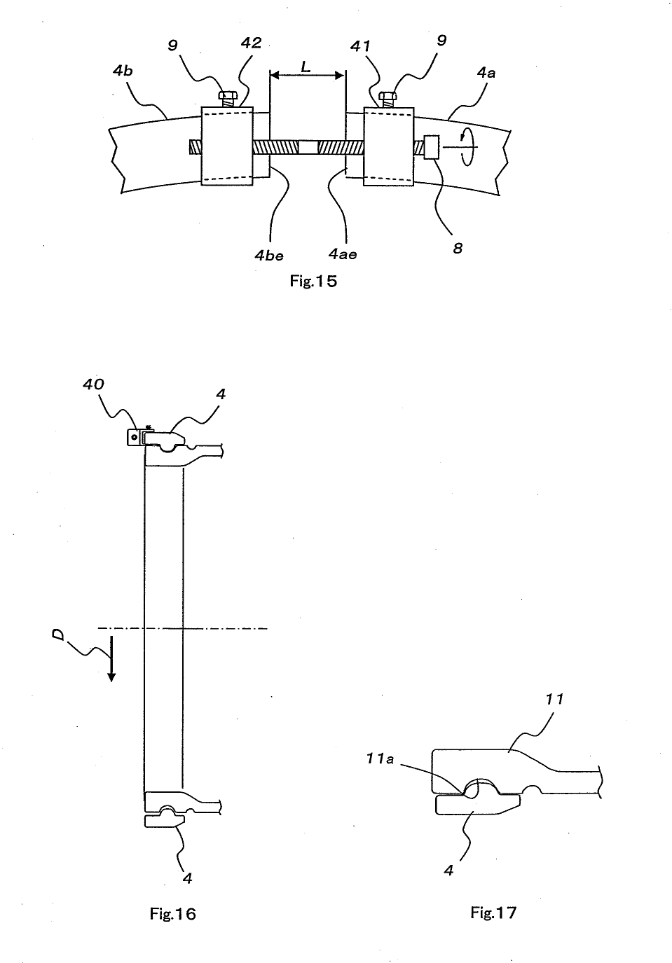

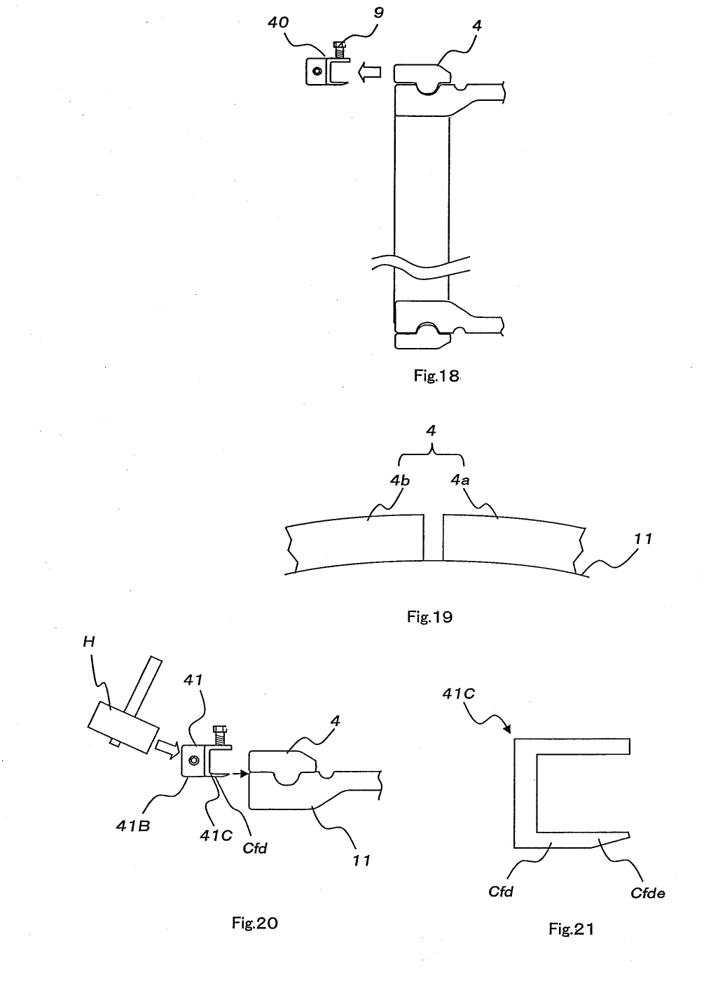

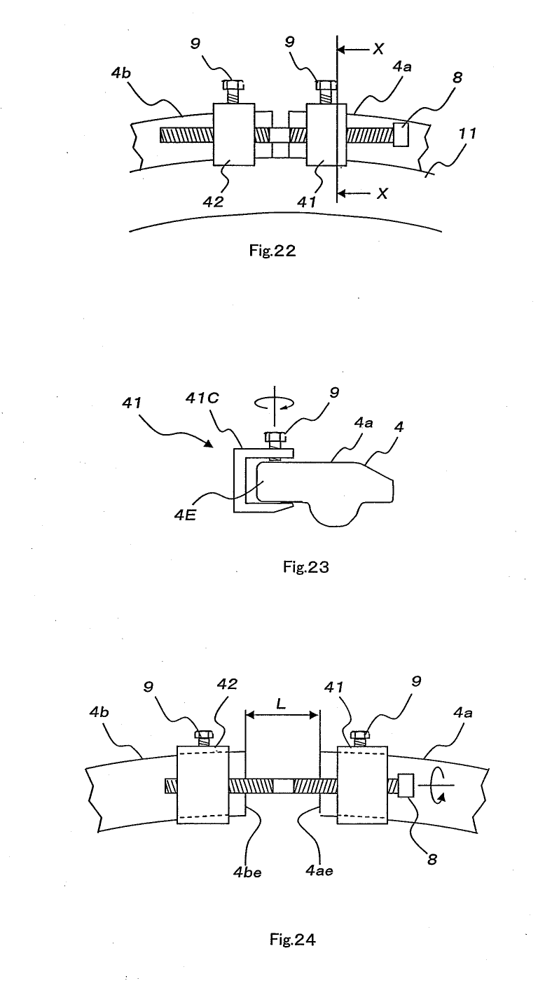

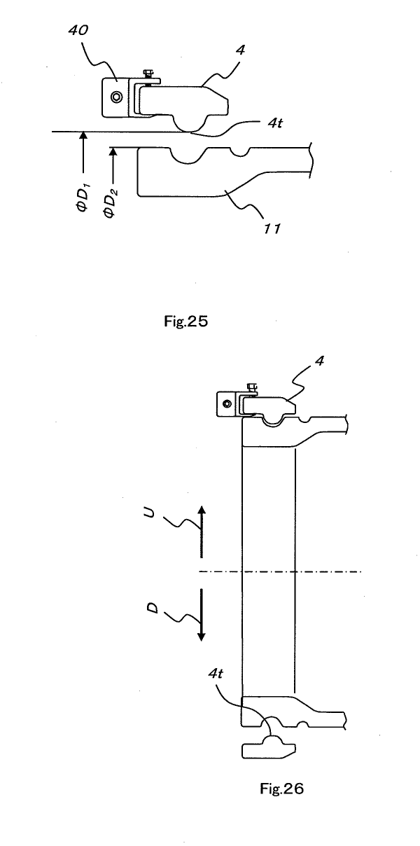

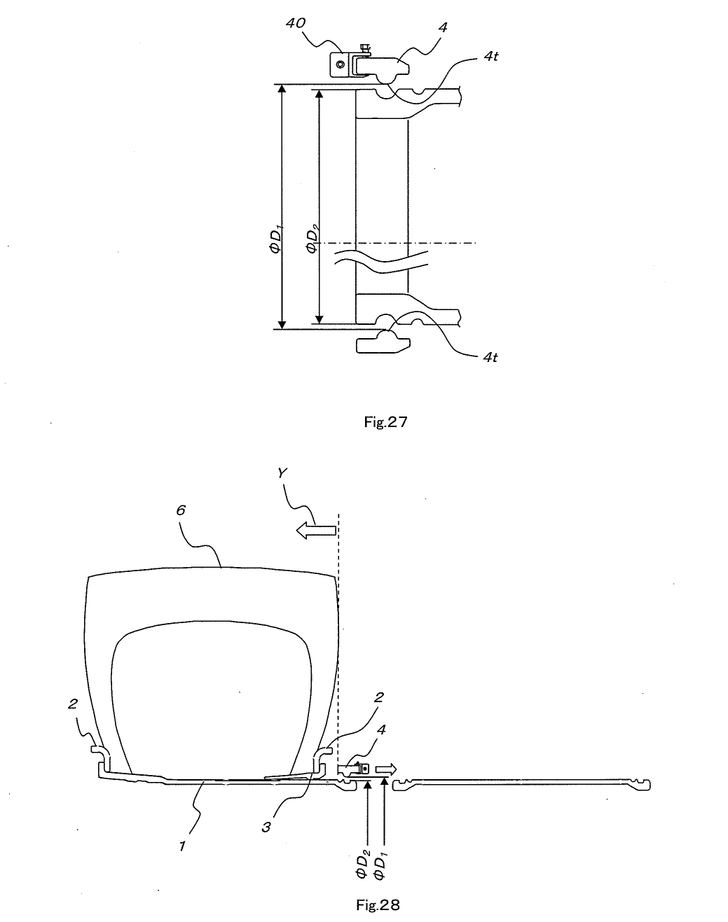

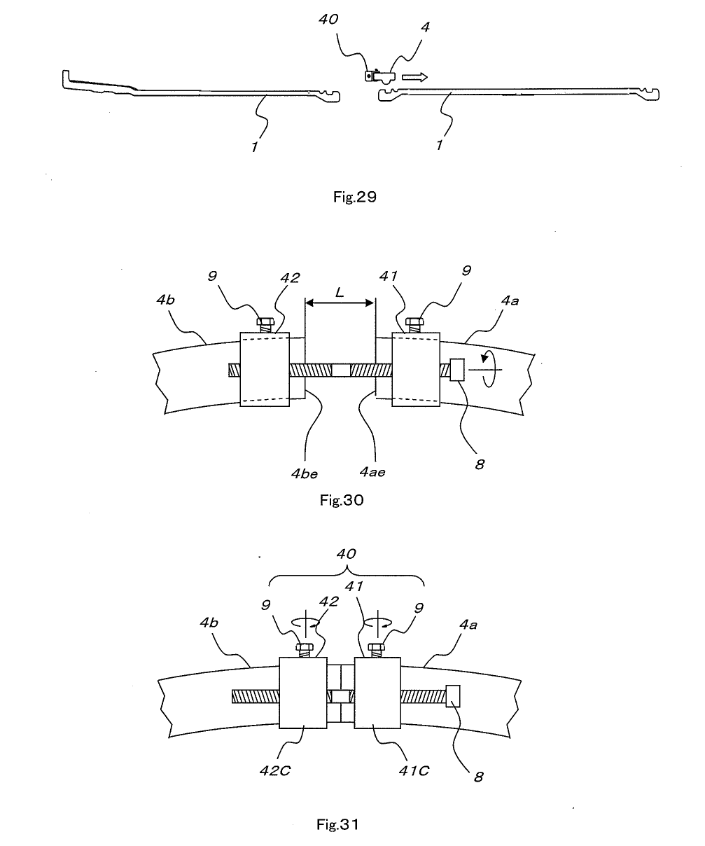

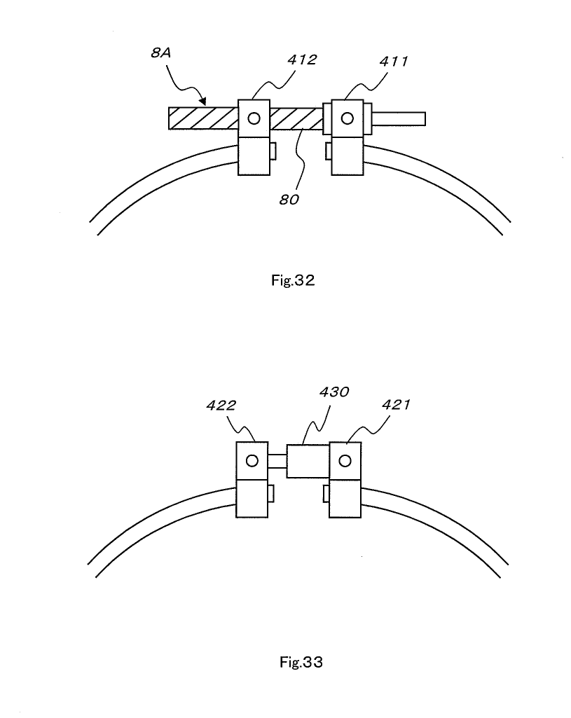

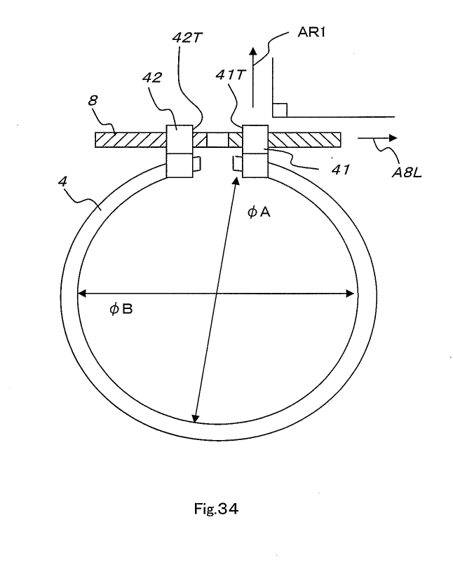

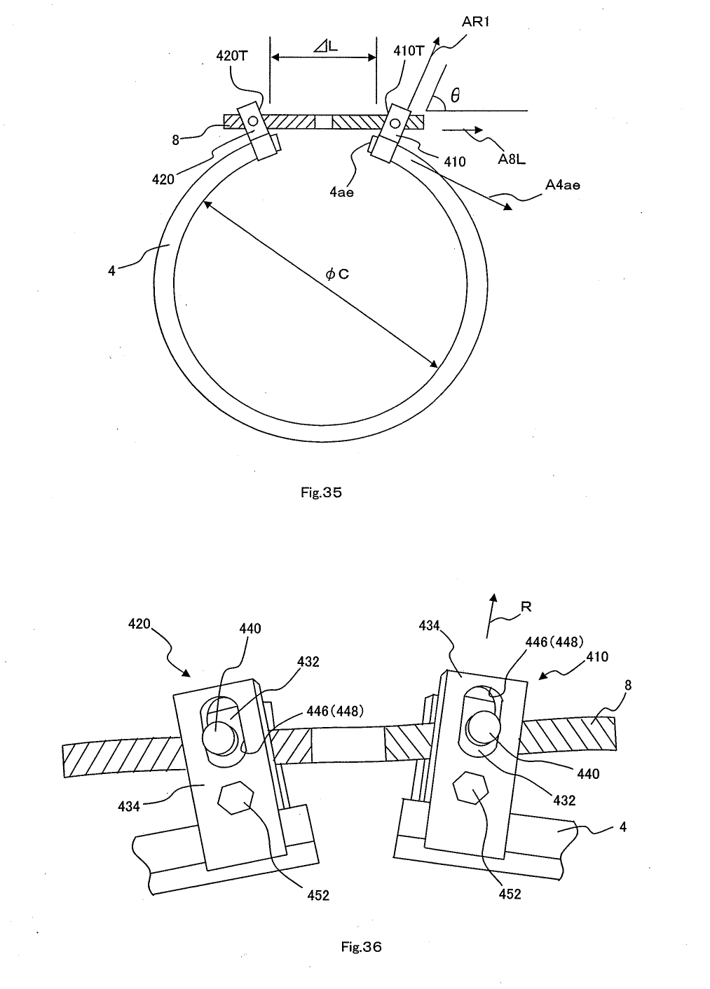

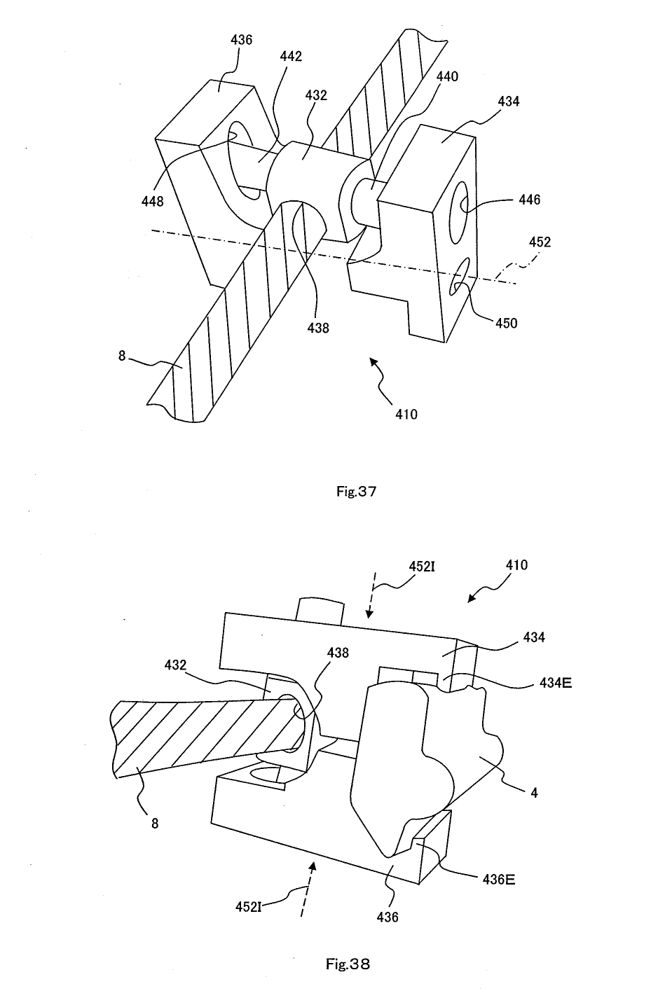

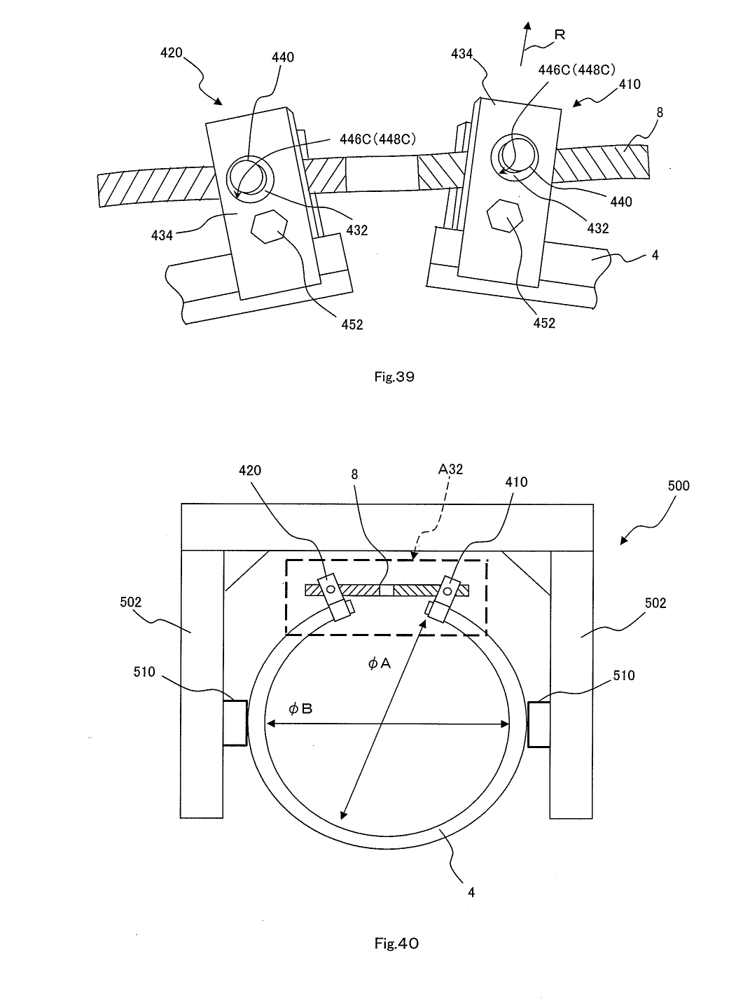

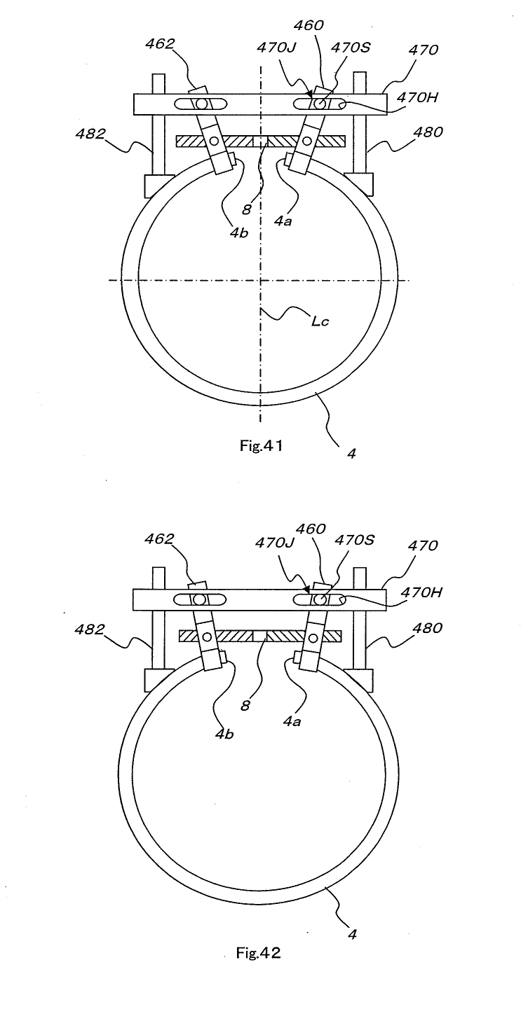

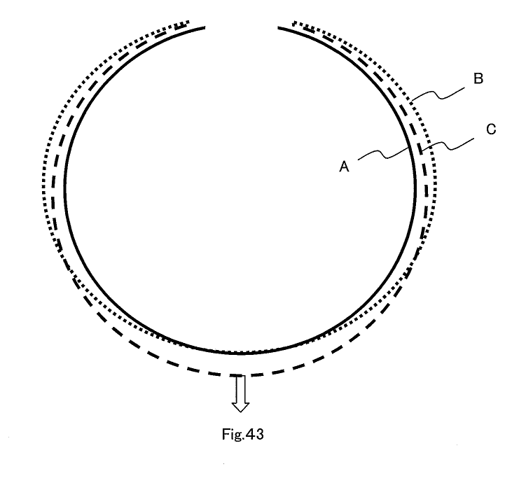

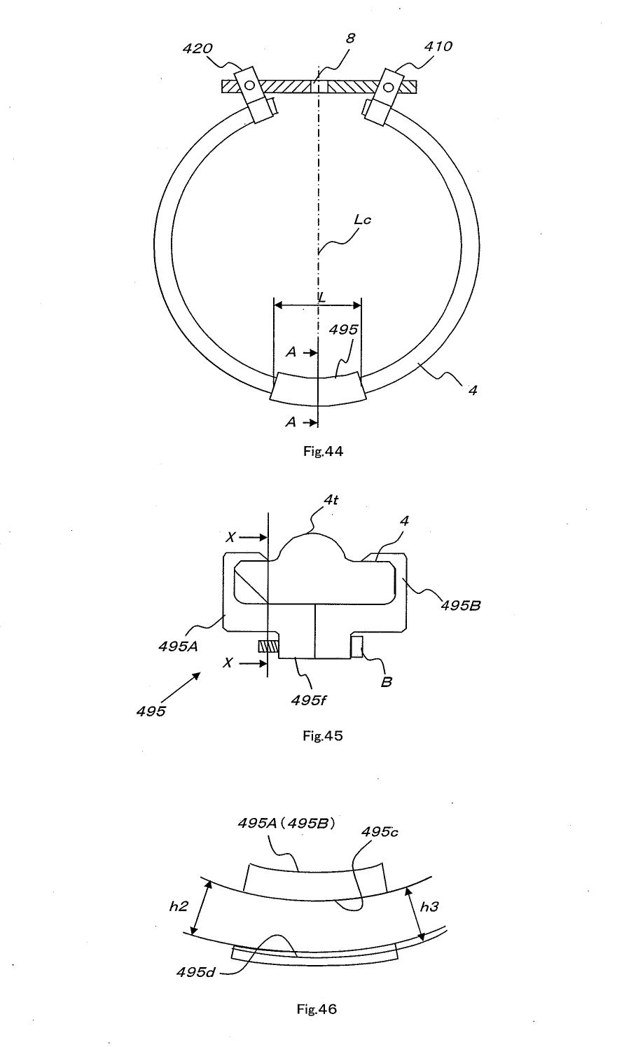

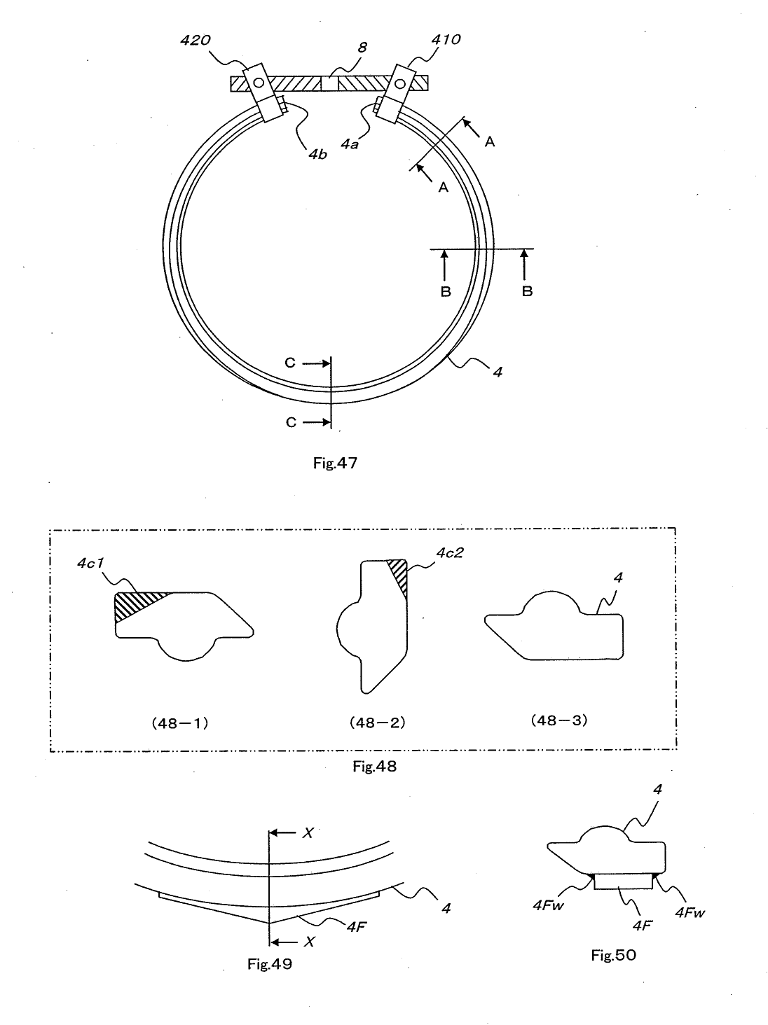

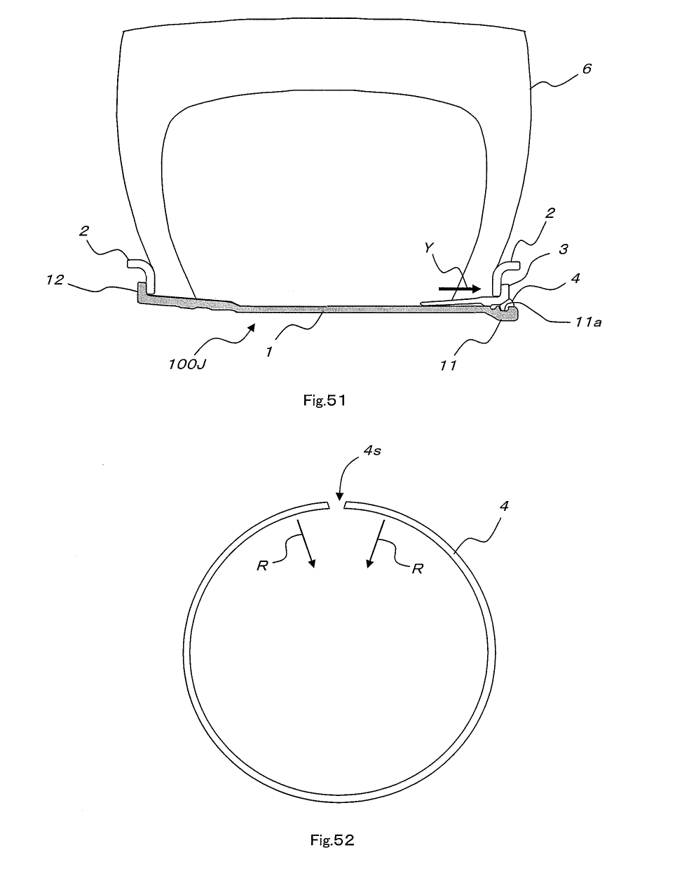

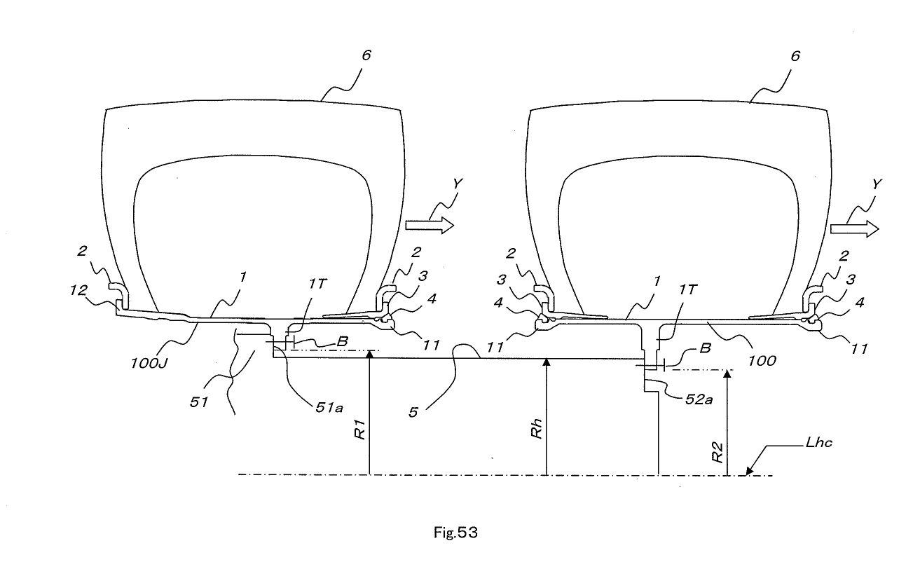

### EXPLANATION OF REFERENCE NUMERALS AND SYMBOLS

1 rim base
2 side ring
3 bead sheet band
4 lock ring
6 tire
8 screw bolt
9 clamp bolt
11 gutter band
40, 41, 42 jig

1. A lock ring mounting/demounting jig, the jig comprising two jigs in pairs, the jigs in pairs being mountable on respective ends of a lock ring, wherein the jigs in pairs are structured such that an interval between the jigs in pairs is stretchable, and the jigs in pairs are attached to an outer peripheral side of a gutter band of a multi-piece rim.

2. The lock ring mounting/demounting jig, according to claim 1, further comprising a perfect circle holding mechanism for suppressing the lock ring from being deformed into the shape of an ellipse when the interval between the jigs is stretched, or shrunk, thereby holding the lock ring in the state of a perfect circle or an approximately perfect circle.

3. The lock ring mounting/demounting jig, according to claim 1, wherein the jigs in pairs, comprising the jig, are joined with each other by a screw bolt, the jigs each include a main block and a clamp, the main block is provided with a female screw, penetrating therethrough, the clamp as a whole is formed in a shape resembling the letter U, having an upper flange, and a lower flange, the upper flange is provided with a through-hole with a female screw formed therein, a clamp bolt being in mesh with the female screw of the through-hole, the lower flange is structured such that a tip thereof is in a pointed shape, the screw bolt has a male screw, the male screw being in mesh with the female screw, penetrating through the jigs in pairs, respectively, the female screw formed in one of the jigs in pairs, so as to penetrate therethrough, has a thread reverse in orientation to a thread of the female screw formed in the other of the jigs so as to penetrate therethrough, and the male screw in a region of the screw bolt, penetrating through the one of the jigs in mesh with the female screw formed in the one of the jigs, has a thread reverse in orientation to a thread of the male screw in the region of the screw bolt, penetrating through the other of the jigs, in mesh with the female screw formed in the other of the jigs, respectively.

4. The lock ring mounting/demounting jig, according to claim 2, wherein the main block is a block with a female screw formed therein so as to penetrate therethrough while the clamp is composed of two clamp members with the block sandwiched therebetween, the block is provided integrally with two lengths of shafts the shafts each being extended in a direction orthogonal to the axial direction of the female screw penetrating through the block, an opening is formed in each of the clamp members the shaft of the block being inserted into the opening of the clamp member, and a through-hole is formed in the clamp member, the clamp members, in a state holding the block sandwiched therebetween, being integrally joined with the block by a bolt inserted into the through-hole.

5. The lock ring mounting/demounting jig, according to claim 2, wherein the jigs in pairs, comprising the jig, are joined with each other by a screw bolt, the jigs each include a main block and a clamp, the main block is provided with a female screw, penetrating therethrough, the clamp as a whole is formed in a shape resembling the letter U, having an upper flange, and a lower flange, the upper flange is provided with a through-hole with a female screw formed therein, a clamp bolt being in mesh with the female screw of the through-hole, the lower flange is structured such that a tip thereof is in a pointed shape, the screw bolt has a male screw, the male screw being in mesh with the female screw, penetrating through the jigs in pairs, respectively, the female screw formed in one of the jigs in pairs, so as to penetrate therethrough, has a thread reverse in orientation to a thread of the female screw formed in the other of the jigs so as to penetrate therethrough, and the male screw in a region of the screw bolt, penetrating through the one of the jigs, in mesh with the female screw formed in the one of the jigs, has a thread reverse in orientation to a thread of the male screw in the region of the screw bolt, penetrating through the other of the jigs, in mesh with the female screw formed in the other of the jigs, respectively.

6. The lock ring mounting/demounting jig, according to claim 3, wherein the main block is a block with a female screw formed therein so as to penetrate therethrough while the clamp is composed of two clamp members with the block sandwiched therebetween, the block is provided integrally with two lengths of shafts, the shafts each being extended in a direction orthogonal to the axial direction of the female screw penetrating through the block, an opening is formed in each of the clamp members, the shaft of the block being inserted into the opening of the clamp member, and a through-hole is formed in the clamp member, the clamp members, in a state holding the block sandwiched therebetween, being integrally joined with the block by a bolt inserted into the through-hole.
